(19) United States
(12) Patent Application Publication
(10) Pub. No.: US 2019/0079597 A1
(43) Pub. Date: Mar. 14, 2019

(54) INFORMATION PROCESSING METHOD, COMPUTER AND PROGRAM

(71) Applicant: COLOPL, Inc., Tokyo (JP)

(72) Inventors: Takeshi KADA, Tokyo (JP); Keisuke NAKAHARA, Tokyo (JP); Koji MIYATA, Tokyo (JP); Yuki KONO, Tokyo (JP)

(21) Appl. No.: 16/125,773

(22) Filed: Sep. 10, 2018

(30) Foreign Application Priority Data
Sep. 13, 2017 (JP) 2017-175650

(51) Int. Cl. G06F 3/03; G06F 3/01; A63F 13/49

(52) U.S. Cl. CPC G06F 3/0325; A63F 13/49; G06F 3/011

(57) ABSTRACT

A method includes identifying a first area in a real space. The method further includes identifying in a virtual space a second area corresponding to the first area. The method further includes detecting in the first area a first position of a part of a body of a user. The method further includes moving, in the second area, an object in the virtual space such that a second position of the object corresponds to the first position. The method further includes determining whether an error occurred in the second position based on the first position failing to be detected correctly. The method further includes moving the object to an erroneous position in the virtual space. The method further includes generating an image including the object at a position immediately before the object has been moved to the erroneous position. The method further includes displaying the image.

### RELATED APPLICATIONS

The present application claims priority to Japanese Application No. 2017-175650, filed on Sep. 13, 2017, the disclosure of which is hereby incorporated by reference herein in its entirety.

### TECHNICAL FIELD

This disclosure relates to an information processing method and a system for performing the same.

### BACKGROUND

In recent years, various types of head-mounted displays capable of enabling a user to experience a virtual reality (VR) space have been developed. Among such head-mounted displays, for a “room scale”-compatible head mounted display, as a preparatory operation, the user performs an operation of setting a play area in a room in which a tracking sensor is arranged (e.g., see Non-Patent Document

Meanwhile, in Patent Document 1, there is described an apparatus configured to issue a warning when the user enters a warning region 50, which is a region at a periphery on an inner side of a sensor measurement area 20.

### RELATED ART

### Patent Documents

[Patent Document 1] JP 2005-165848 A

### Non-Patent Documents

[Non-Patent Document 1] “Pick a Play Area”, [online], [retrieved on Aug. 18, 2017], Internet <https://www.vive.com/jp/support/category_howto/choosing-your-play-area.html>

### SUMMARY

According to at least one embodiment of this disclosure, there is provided an information processing method including identifying a three-dimensional first area in a real space. The method further includes identifying in a three-dimensional virtual space a three-dimensional second area corresponding to the first area. The method further includes detecting in the first area a position of a part of a body of a user associated with a head-mounted device (HMD) when the part of the body is positioned in the first area. The method further includes moving in the second area an object in the virtual space such that the object corresponds to the position of the at least a part of the body of the user. The method further includes detecting an error in a position of the object in the virtual space, the error being caused by the position of the at least a part of the body failing to be detected correctly. The method further includes moving the object to an erroneous position in the virtual space. The method further includes generating an image for showing a position in the second area in accordance with the detection of the error, the position in the second area being a position in the virtual space immediately before the object has been moved to the erroneous position. The method further includes generating a visual-field image of the virtual space such that the image is included in the visual-field image. The method further includes displaying the visual-field image on the HMD.

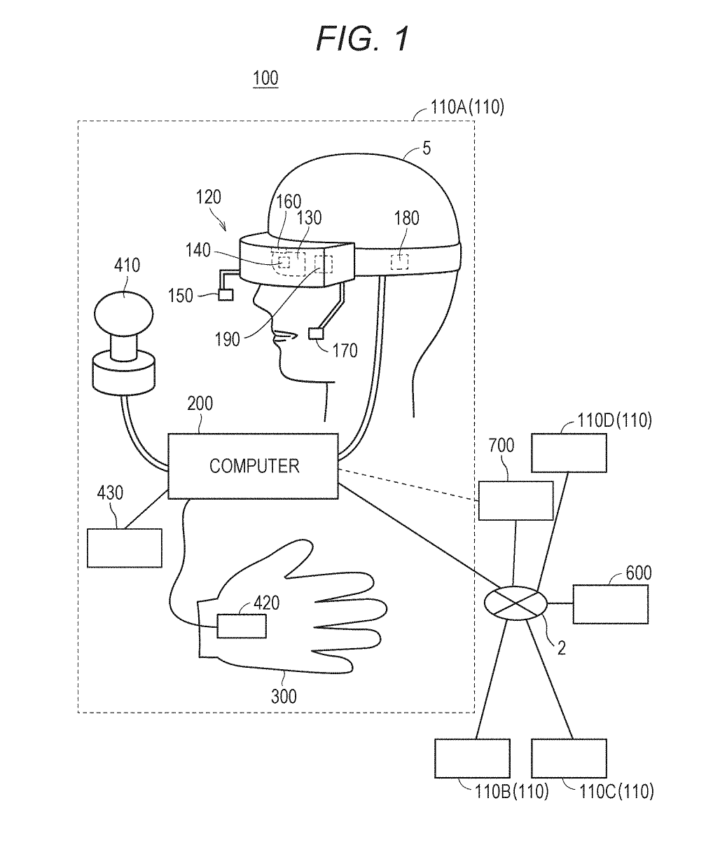

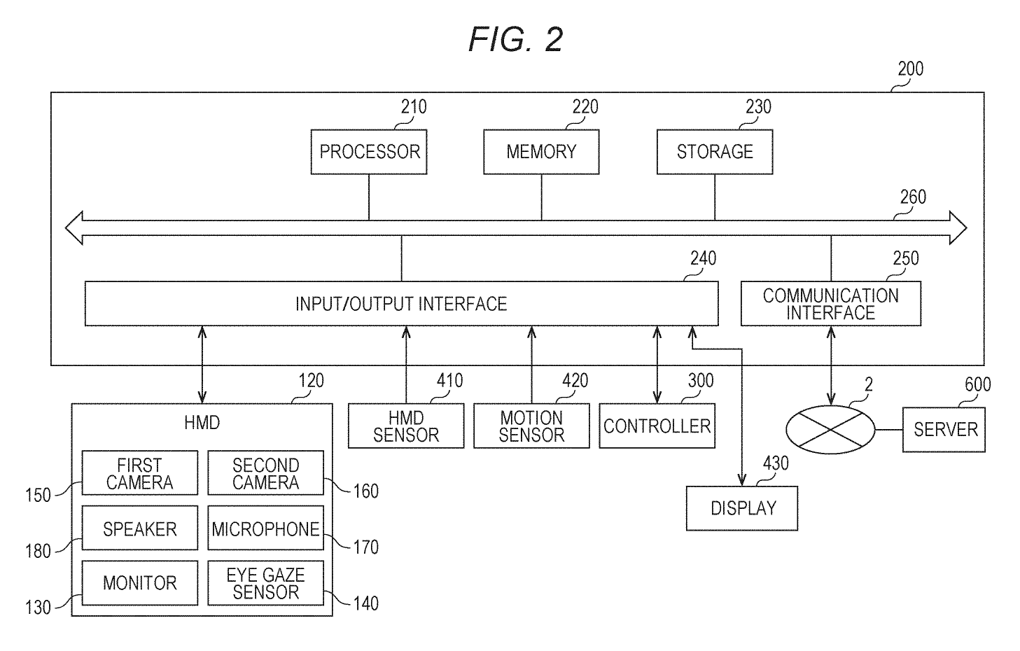

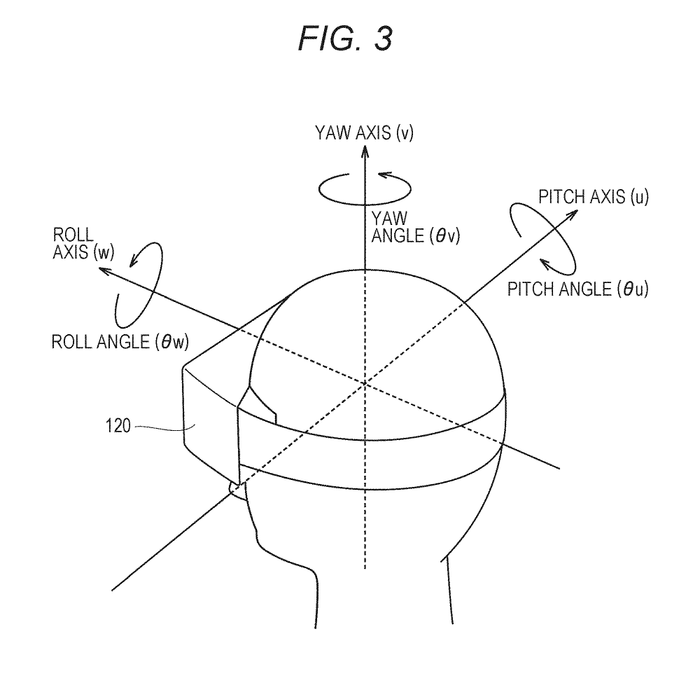

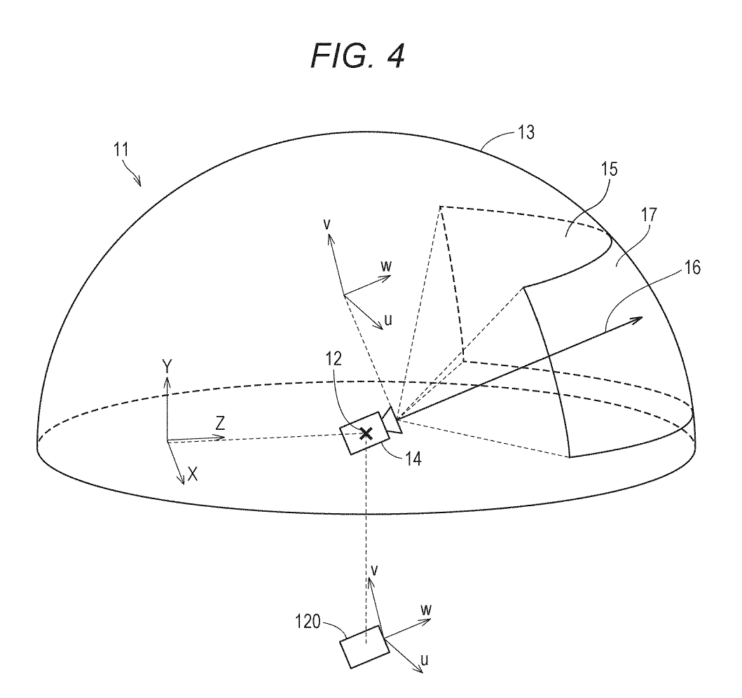

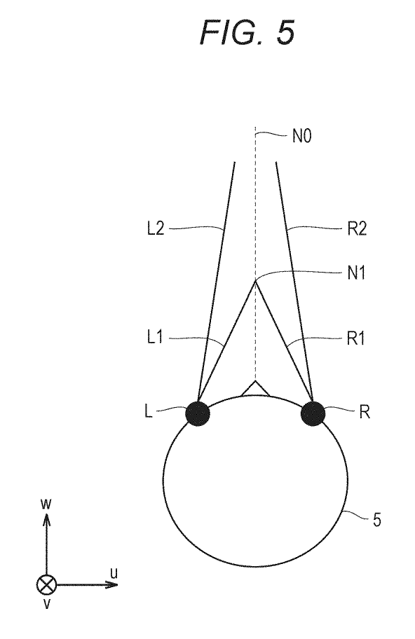

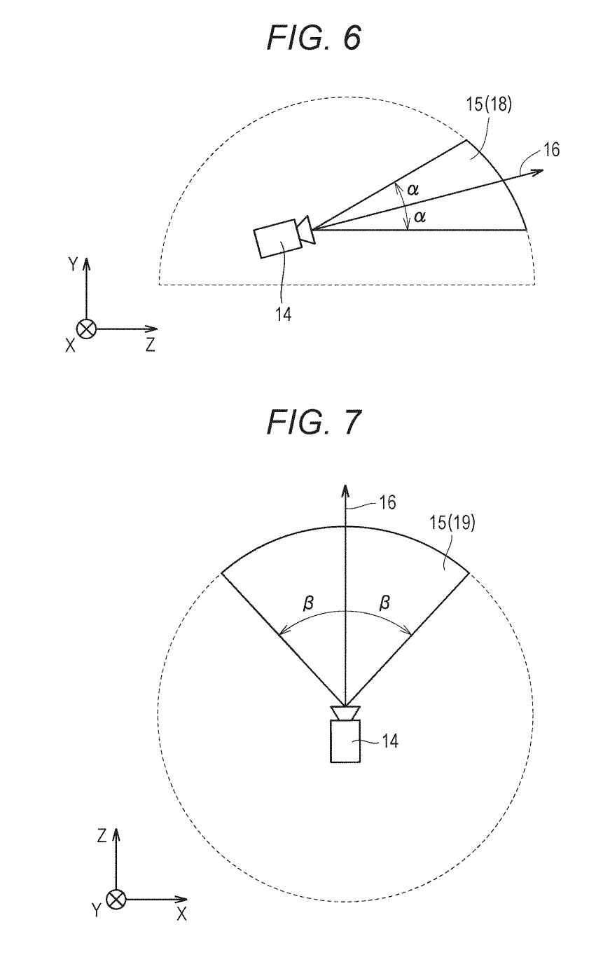

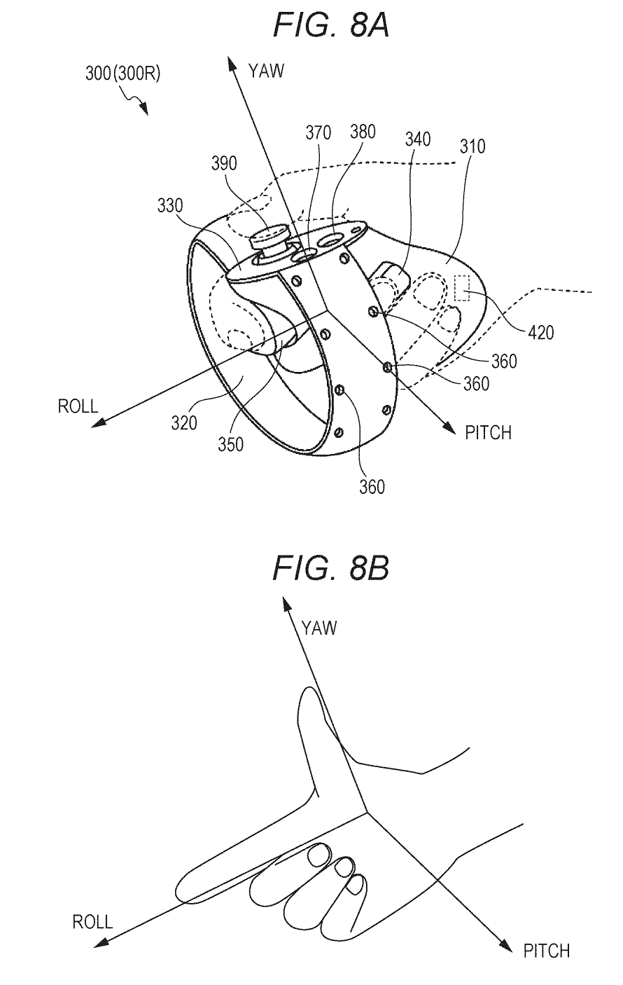

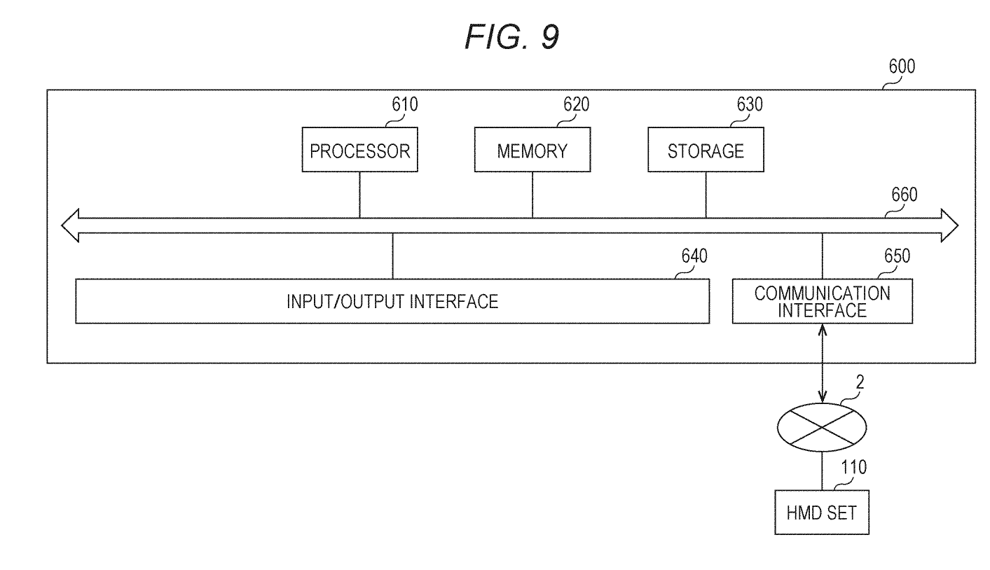

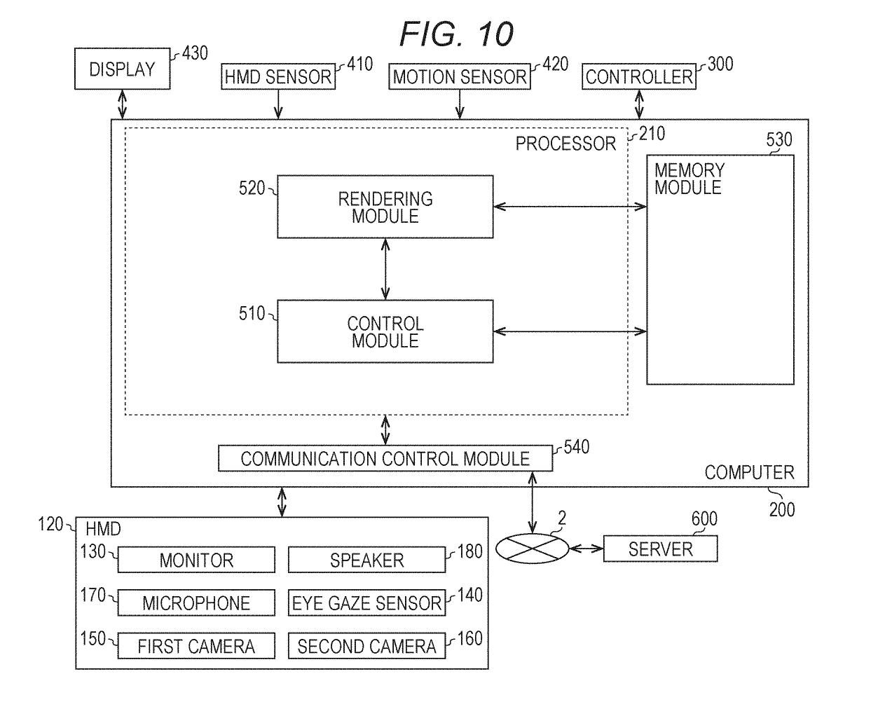

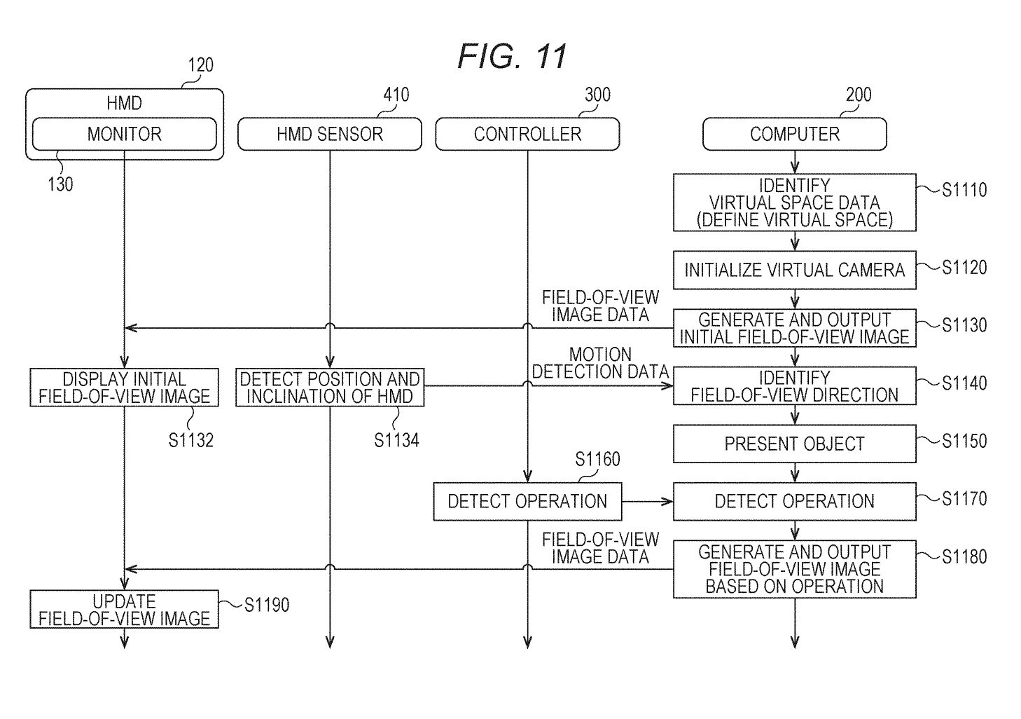

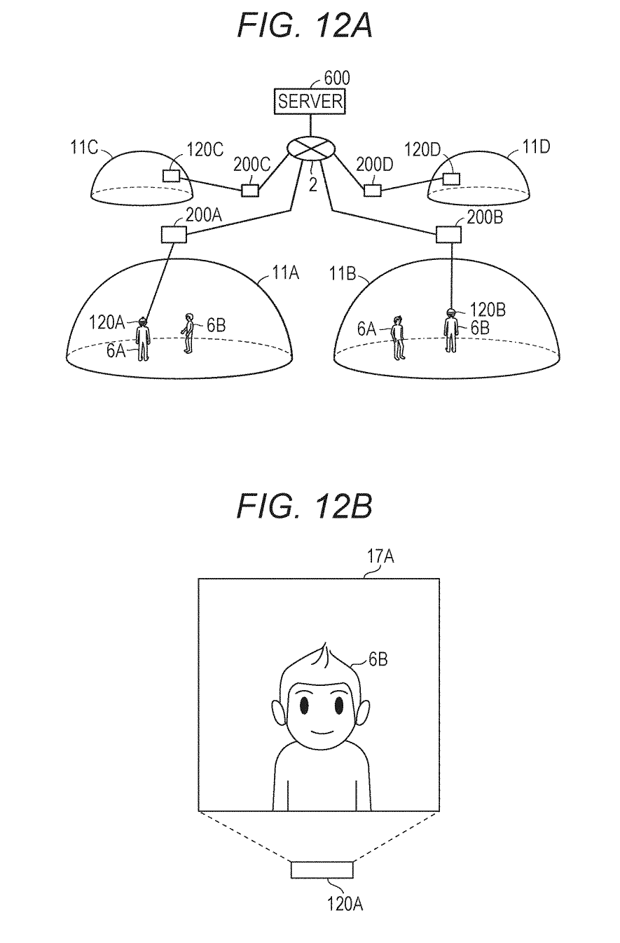

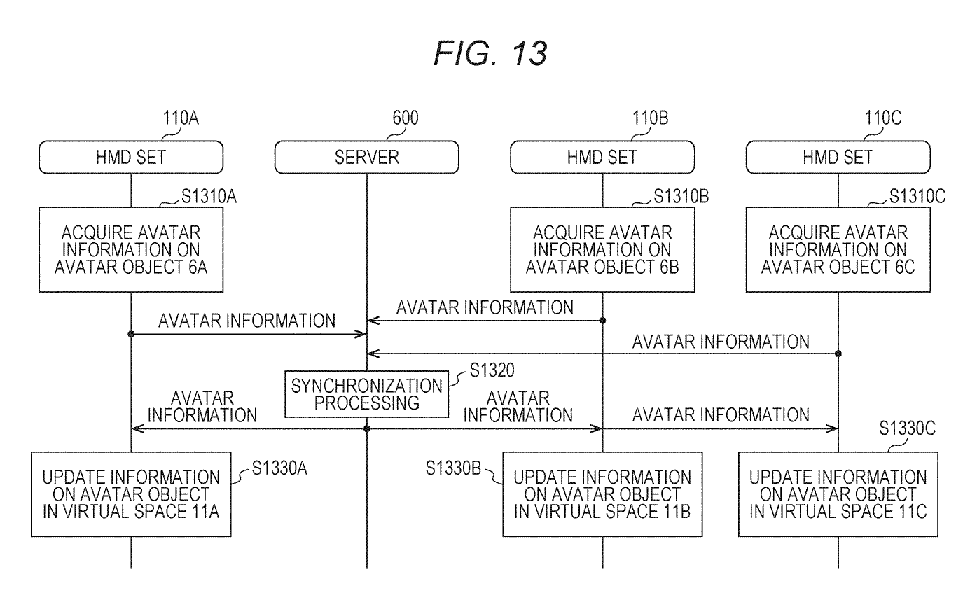

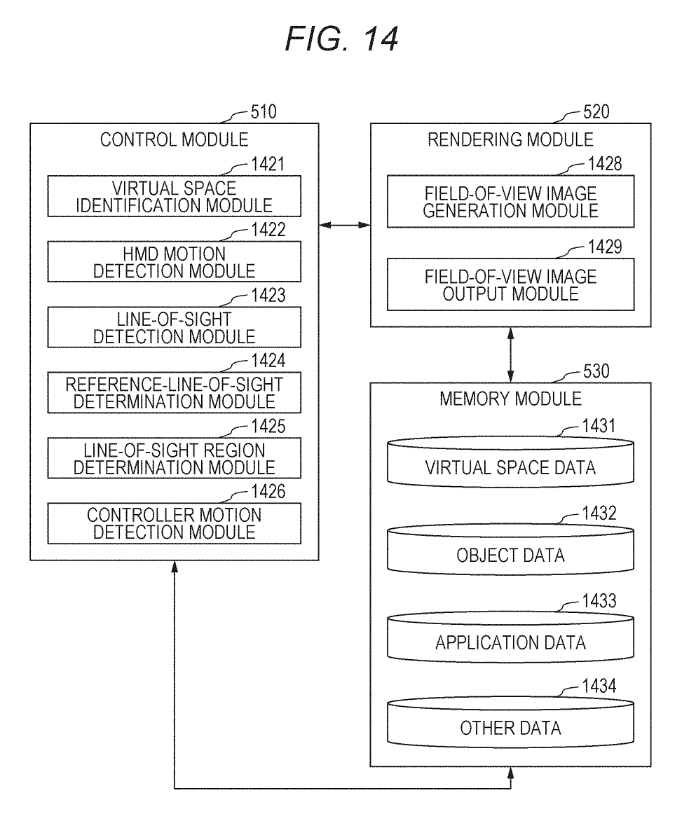

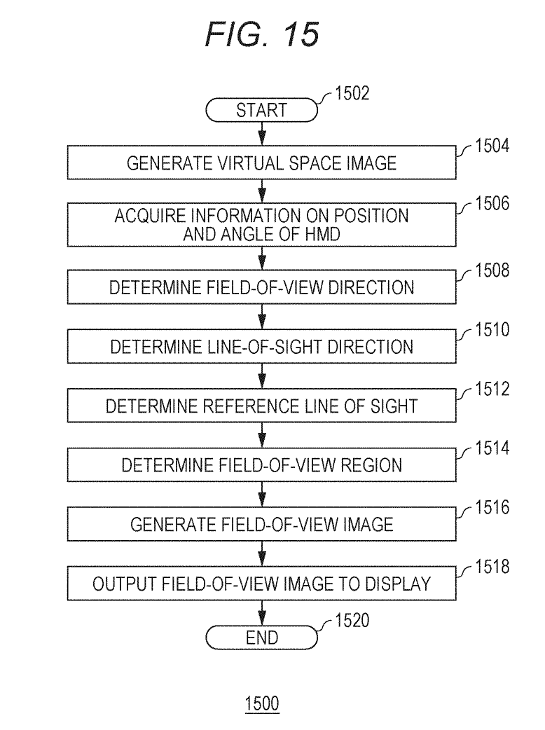

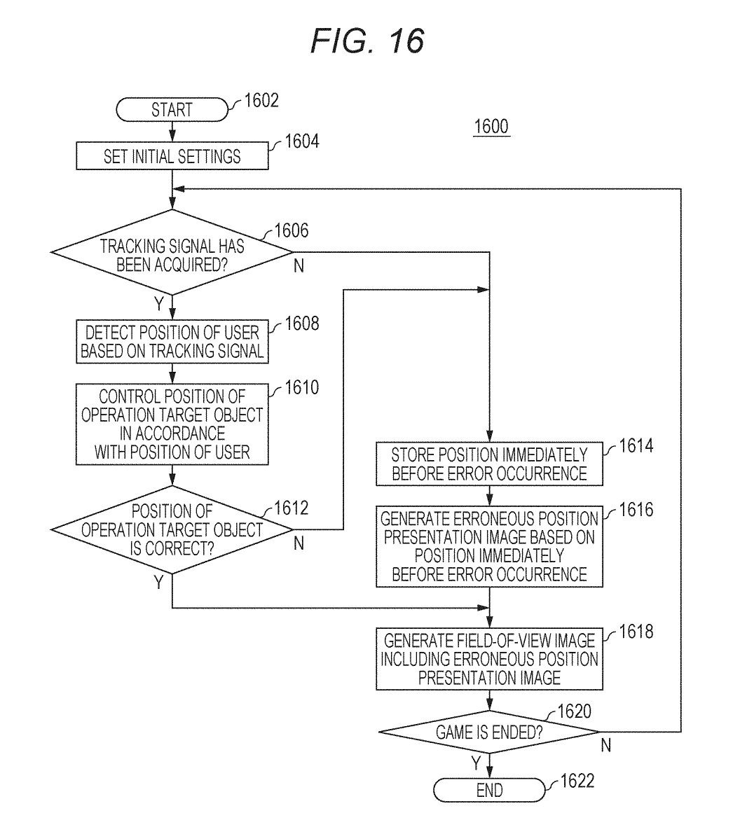

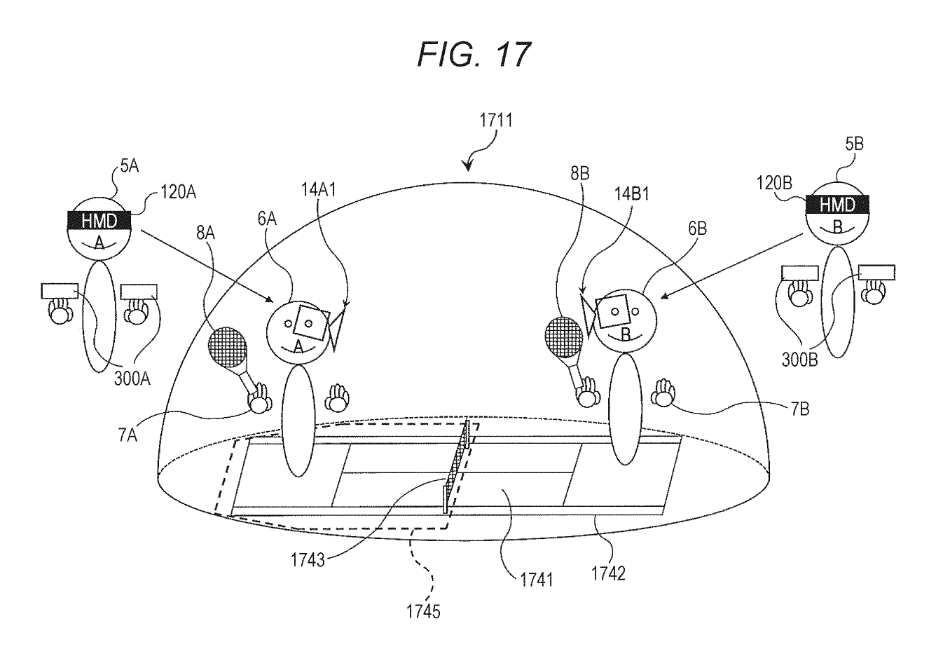

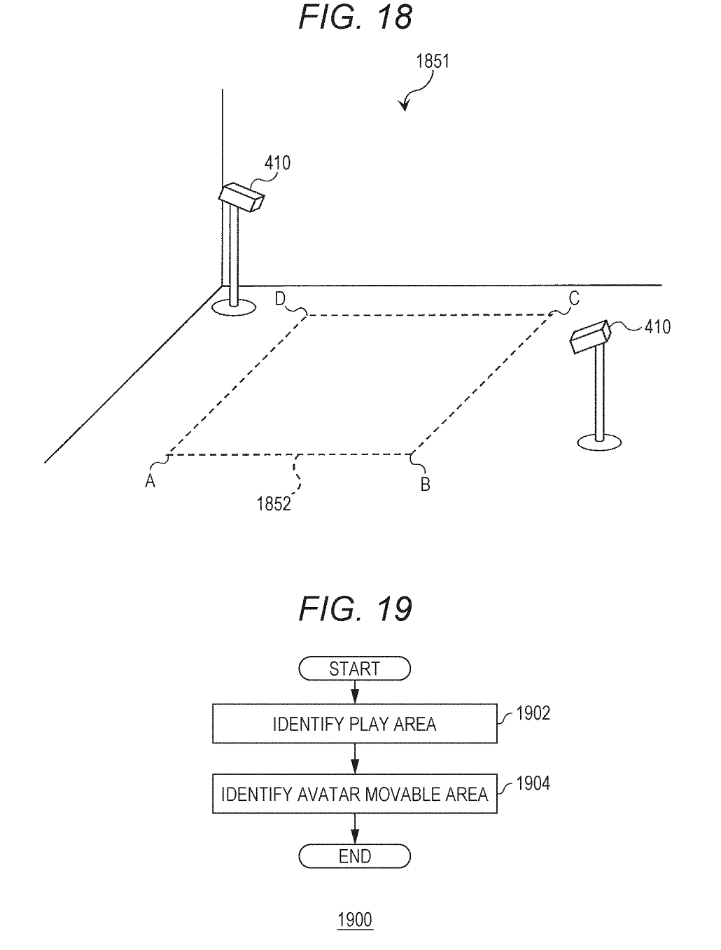

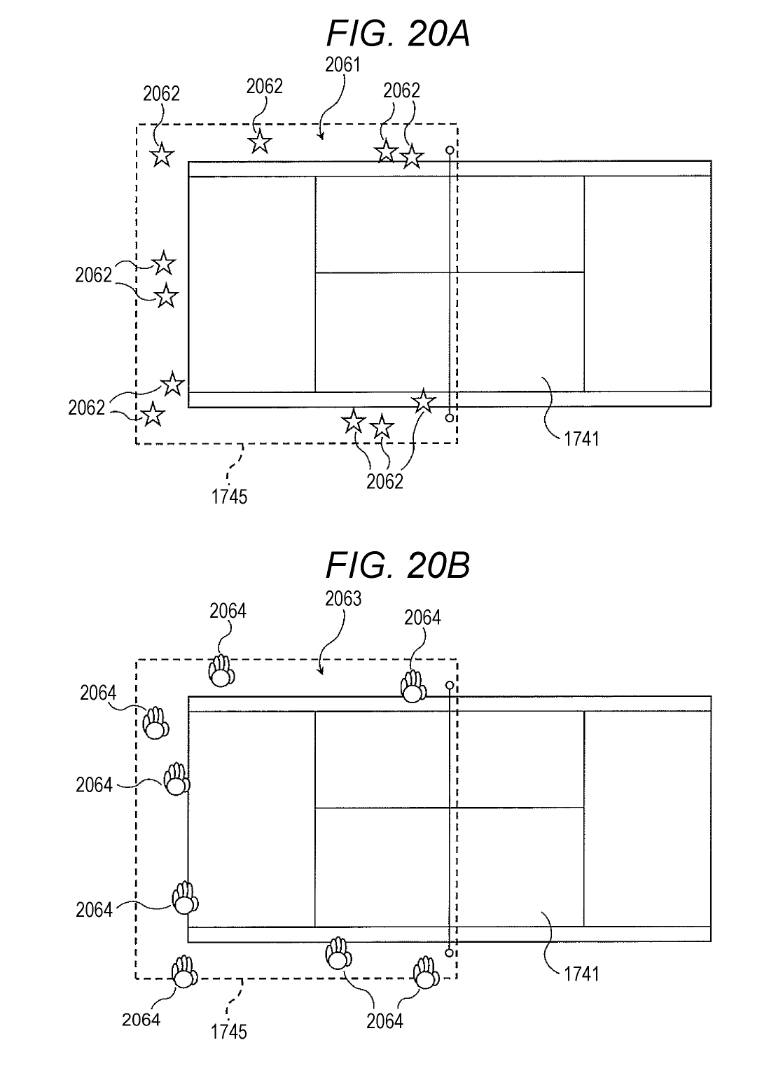

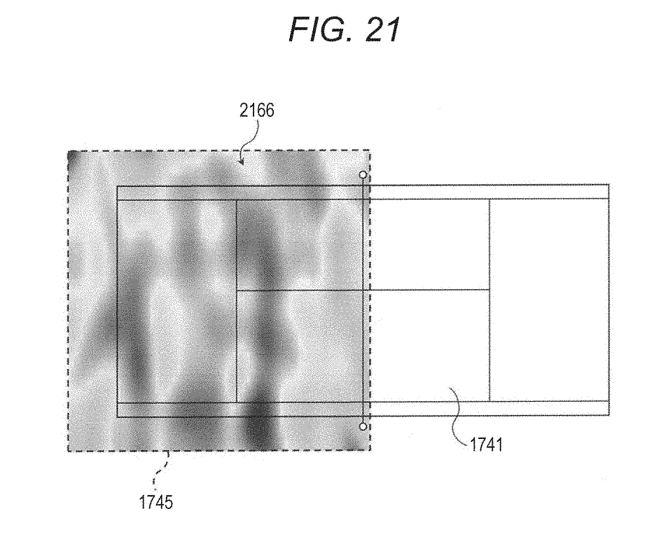

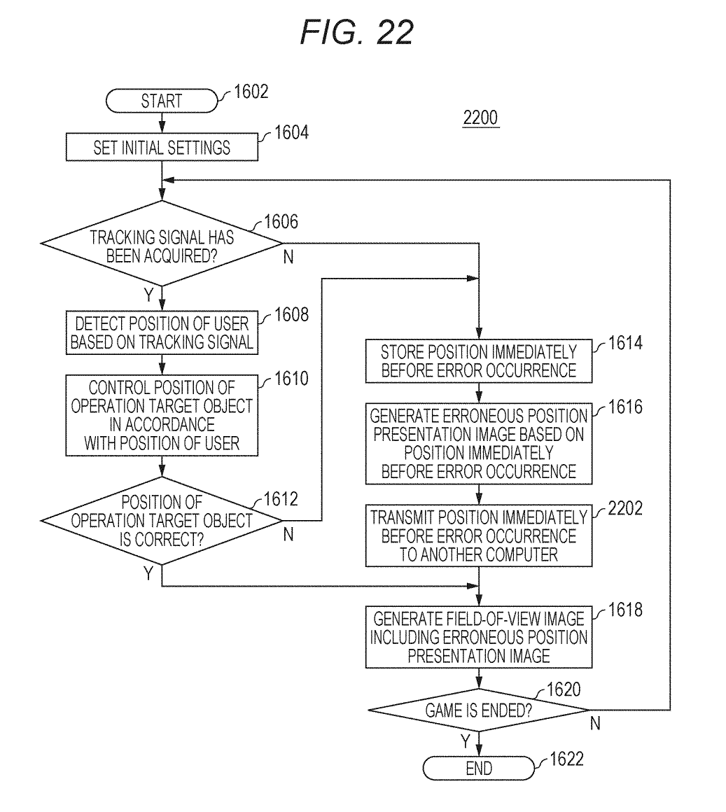

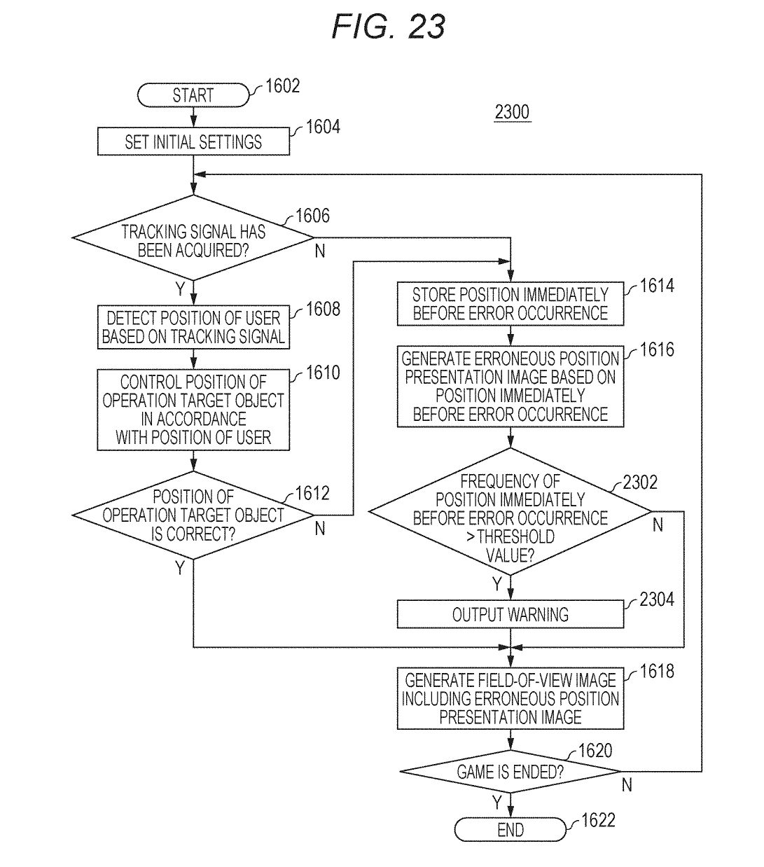

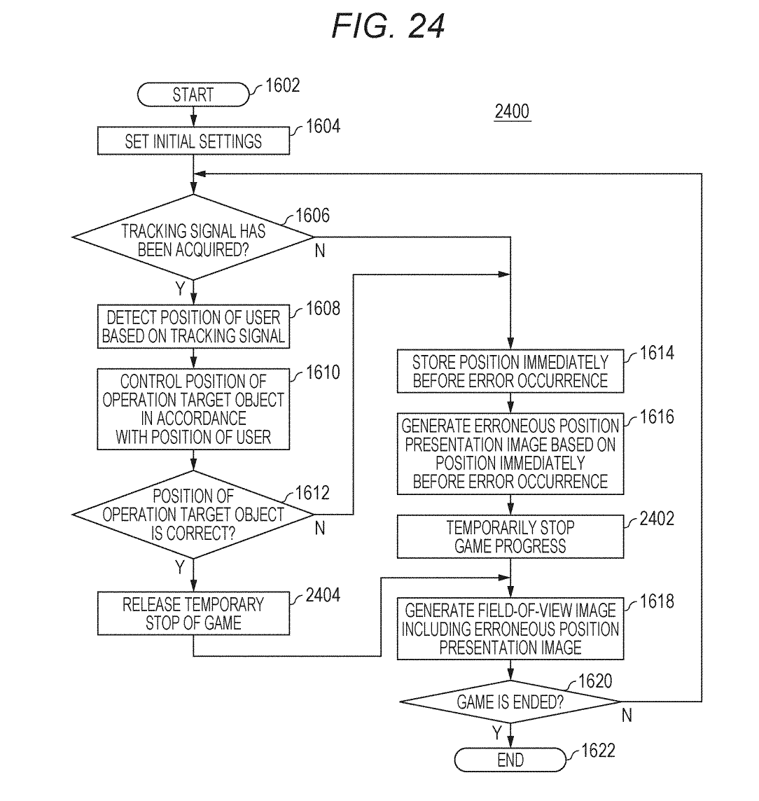

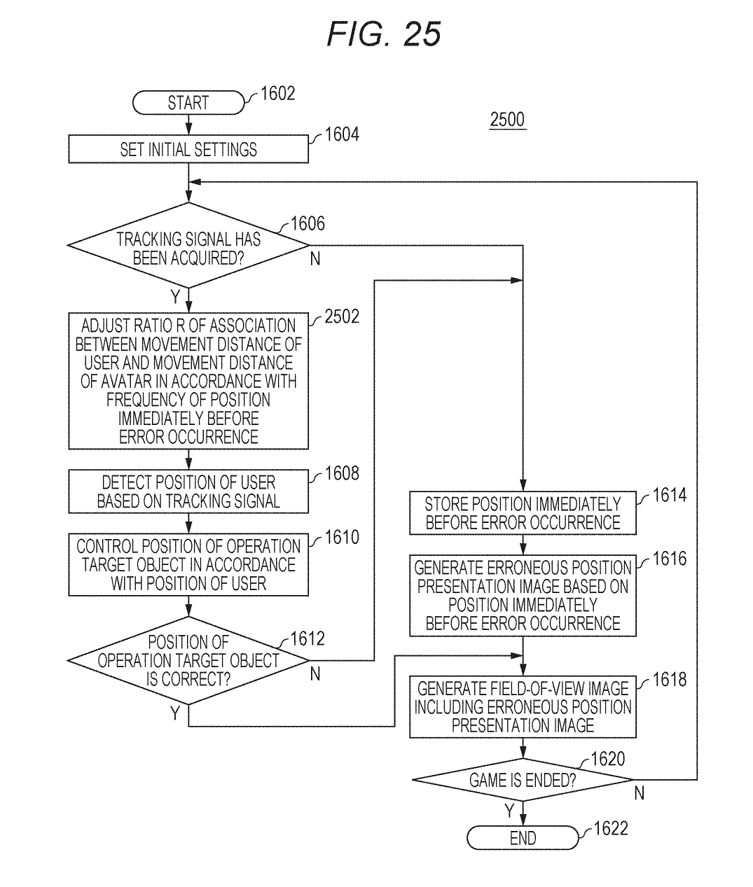

### BRIEF DESCRIPTION OF THE DRAWINGS

[FIG. 1] A diagram of a system including a head-mounted device (HMD) according to at least one embodiment of this disclosure.

[FIG. 2] A block diagram of a hardware configuration of a computer according to at least one embodiment of this disclosure.

[FIG. 3] A diagram of a uvw visual-field coordinate system to be set for an HMD according to at least one embodiment of this disclosure.

[FIG. 4] A diagram of a mode of expressing a virtual space according to at least one embodiment of this disclosure.

[FIG. 5] A diagram of a plan view of a head of a user wearing the HMD according to at least one embodiment of this disclosure.

[FIG. 6] A diagram of a YZ cross section obtained by viewing a field-of-view region from an X direction in the virtual space according to at least one embodiment of this disclosure.

[FIG. 7] A diagram of an XZ cross section obtained by viewing the field-of-view region from a Y direction in the virtual space according to at least one embodiment of this disclosure.

[FIG. 8A] A diagram of a schematic configuration of a controller according to at least one embodiment of this disclosure.

[FIG. 8B] A diagram of a coordinate system to be set for a hand of a user holding the controller according to at least one embodiment of this disclosure.

[FIG. 9] A block diagram of a hardware configuration of a server according to at least one embodiment of this disclosure.

[FIG. 10] A block diagram of a computer according to at least one embodiment of this disclosure.

[FIG. 11] A sequence chart of processing to be executed by a system including an HMD set according to at least one embodiment of this disclosure.

[FIG. 12A] A schematic diagram of HMD systems of several users sharing the virtual space interact using a network according to at least one embodiment of this disclosure.

[FIG. 12B] A diagram of a field of view image of a HMD according to at least one embodiment of this disclosure.

[FIG. 13] A sequence diagram of processing to be executed by a system including an HMD interacting in a network according to at least one embodiment of this disclosure.

[FIG. 14] A block diagram of a computer according to at least one embodiment of this disclosure.

[FIG. 15] A flowchart of processing for displaying on a display an image of the virtual space in which the user is to be immersed according to at least one embodiment of this disclosure.

[FIG. 16] A flowchart of a method according to at least one embodiment of this disclosure.

[FIG. 17] A schematic diagram of a game according to at least one embodiment of this disclosure.

[FIG. 18] A diagram of a room at the home of the user according to at least one embodiment of this disclosure.

[FIG. 19] A flowchart of a method for setting initial settings according to at least one embodiment of this disclosure.

[FIG. 20A] A diagram of an erroneous position presentation image according to at least one embodiment of this disclosure.

[FIG. 20B] A diagram of an erroneous position presentation image according to at least one embodiment of this disclosure.

[FIG. 21] A diagram of an erroneous position presentation image according to at least one embodiment of this disclosure.

[FIG. 22] A flowchart of a method according to at least one embodiment of this disclosure.

[FIG. 23] A flowchart of a method according to at least one embodiment of this disclosure.

[FIG. 24] A flowchart of a method according to at least one embodiment of this disclosure.

[FIG. 25] A flowchart of a method according to at least one embodiment of this disclosure.

### DETAILED DESCRIPTION

[Description of Embodiments of this Disclosure]

First, there are listed examples of details of some embodiments of this disclosure for description. At least one embodiment of this disclosure is configured as follows.

(Item 1)

An information processing method includes identifying a first area in a real space. The method further includes identifying a second area in a virtual space corresponding to the first area. The method further includes detecting a position of at least a part of a body of a user in the first area. The method further includes moving in the second area an object in the virtual space in accordance with the position of the at least a part of the body of the user. The method further includes detecting an error in a position of the object in the virtual space, wherein the error is caused by the position of the at least a part of the body of the user failing to be correctly detected. The method further includes generating, based on the detection of the error, an image for showing a position in the second area immediately before the object has been moved to the erroneous position. The method further includes generating a visual-field image of the virtual space such that the image is included.

(Item 2)

The information processing method according to Item 1, wherein the detecting of the error includes determining whether the error has occurred based on a temporal change in the position of the object in the virtual space.

(Item 3)

The information processing method according to Item 2, wherein the detecting of the error includes determining that the error has occurred when the temporal change in the position of the object in the virtual space is larger than a predetermined threshold value.

(Item 4)

The information processing method according to any one of Items 1 to 3, wherein the image is expressed by mapping in the virtual space each position in the second area immediately before the object has been moved to each erroneous position based on a history in which the error is detected one or a plurality of times.

(Item 5)

The information processing method according to Item 4, wherein the image includes an image expressed as a spatial distribution of shading, color, pattern, or graphics, or includes an image of the same object as the object or an image in which the object is changed.

(Item 6)

The information processing method according to Items 4 or 5, wherein the image is updated based on the history acquired within a period of time having a predetermined length including a current point in time.

(Item 7)

The information processing method according to any one of Items 1 to 6, further including transmitting information on the detection of the error to a terminal of another user sharing the virtual space with the user.

(Item 8)

The information processing method according to any one of Items 1 to 7, further including determining whether a frequency at which the error is detected is higher than a threshold frequency; and issuing a warning to the user when the frequency is higher than the threshold frequency.

(Item 9)

The information processing method according to Item 8, further including monitoring a behavior of the user; and adjusting the threshold frequency based on the behavior of the user.

(Item 10)

The information processing method according to Item 9, wherein the behavior of the user includes at least one of a number of times that the error is detected, a period of time from detection of the error until resolution of the error, or a movement amount of the at least a part of the body of the user in the real space.

(Item 11)

The information processing method according to any one of Items 1 to 10, further including temporarily stopping progress of a game in the virtual space when the error has been detected.

(Item 12)

The information processing method according to any one of Items 1 to 11, further including setting a ratio for defining a distance by which the object is to move in the virtual space when the at least a part of the body of the user has been moved in the real space by a unit distance; and adjusting the ratio in accordance with a frequency at which the error is detected.

(Item 13)

The information processing method according to Item 12, wherein the adjusting of the ratio includes identifying for each direction in the virtual space a frequency at which the error is detected; and adjusting the ratio for each direction in the virtual space in accordance with the frequency for each direction in the virtual space.

(Item 14)

A system includes a processor; and a memory configured to store a program. The program causes the processor to execute the information processing method of any one of Items 1 to 13 when the program is executed by the processor.

(Item 15)

A non-transitory computer readable medium storing instructions for causing a processor to execute the information processing method of any one of Items 1 to 13.

Now, with reference to the drawings, embodiments of this technical idea are described in detail. In the following description, like components are denoted by like reference symbols. The same applies to the names and functions of those components. Therefore, detailed description of those components is not repeated. In one or more embodiments described in this disclosure, components of respective embodiments can be combined with each other, and the combination also serves as a part of the embodiments described in this disclosure.

[Configuration of HMD System]

With reference to FIG. 1, a configuration of a head-mounted device (HMD) system 100 is described. FIG. 1 is a diagram of a system 100 including a head-mounted display (HMD) according to at least one embodiment of this disclosure. The system 100 is usable for household use or for professional use.

The system 100 includes a server 600, HMD sets 110A, 110B, 110C, and 110D, an external device 700, and a network 2. Each of the HMD sets 110A, 110B, 110C, and 110D is capable of independently communicating to/from the server 600 or the external device 700 via the network 2. In some instances, the HMD sets 110A, 110B, 110C, and 110D are also collectively referred to as “HMD set 110”. The number of HMD sets 110 constructing the HMD system 100 is not limited to four, but may be three or less, or five or more. The HMD set 110 includes an HMD 120, a computer 200, an HMD sensor 410, a display 430, and a controller 300. The HMD 120 includes a monitor 130, an eye gaze sensor 140, a first camera 150, a second camera 160, a microphone 170, and a speaker 180. In at least one embodiment, the controller 300 includes a motion sensor 420.

In at least one aspect, the computer 200 is connected to the network 2, for example, the Internet, and is able to communicate to/from the server 600 or other computers connected to the network 2 in a wired or wireless manner. Examples of the other computers include a computer of another HMD set 110 or the external device 700. In at least one aspect, the HMD 120 includes a sensor 190 instead of the HMD sensor 410. In at least one aspect, the HMD 120 includes both sensor 190 and the HMD sensor 410.

The HMD 120 is wearable on a head of a user 5 to display a virtual space to the user 5 during operation. More specifically, in at least one embodiment, the HMD 120 displays each of a right-eye image and a left-eye image on the monitor 130. Each eye of the user 5 is able to visually recognize a corresponding image from the right-eye image and the left-eye image so that the user 5 may recognize a three-dimensional image based on the parallax of both of the user's the eyes. In at least one embodiment, the HMD 120 includes any one of a so-called head-mounted display including a monitor or a head-mounted device capable of mounting a smartphone or other terminals including a monitor.

The monitor 130 is implemented as, for example, a non-transmissive display device. In at least one aspect, the monitor 130 is arranged on a main body of the HMD 120 so as to be positioned in front of both the eyes of the user 5. Therefore, when the user 5 is able to visually recognize the three-dimensional image displayed by the monitor 130, the user 5 is immersed in the virtual space. In at least one aspect, the virtual space includes, for example, a background, objects that are operable by the user 5, or menu images that are selectable by the user 5. In at least one aspect, the monitor 130 is implemented as a liquid crystal monitor or an organic electroluminescence (EL) monitor included in a so-called smartphone or other information display terminals.

In at least one aspect, the monitor 130 is implemented as a transmissive display device. In this case, the user 5 is able to see through the HMD 120 covering the eyes of the user 5, for example, smartglasses. In at least one embodiment, the transmissive monitor 130 is configured as a temporarily non-transmissive display device through adjustment of a transmittance thereof. In at least one embodiment, the monitor 130 is configured to display a real space and a part of an image constructing the virtual space simultaneously. For example, in at least one embodiment, the monitor 130 displays an image of the real space captured by a camera mounted on the HMD 120, or may enable recognition of the real space by setting the transmittance of a part the monitor 130 sufficiently high to permit the user 5 to see through the HMD 120.

In at least one aspect, the monitor 130 includes a sub-monitor for displaying a right-eye image and a sub-monitor for displaying a left-eye image. In at least one aspect, the monitor 130 is configured to integrally display the right-eye image and the left-eye image. In this case, the monitor 130 includes a high-speed shutter. The high-speed shutter operates so as to alternately display the right-eye image to the right of the user 5 and the left-eye image to the left eye of the user 5, so that only one of the user's 5 eyes is able to recognize the image at any single point in time.

In at least one aspect, the HMD 120 includes a plurality of light sources (not shown). Each light source is implemented by, for example, a light emitting diode (LED) configured to emit an infrared ray. The HMD sensor 410 has a position tracking function for detecting the motion of the HMD 120. More specifically, the HMD sensor 410 reads a plurality of infrared rays emitted by the HMD 120 to detect the position and the inclination of the HMD 120 in the real space.

In at least one aspect, the HMD sensor 410 is implemented by a camera. In at least one aspect, the HMD sensor 410 uses image information of the HMD 120 output from the camera to execute image analysis processing, to thereby enable detection of the position and the inclination of the HMD 120.

In at least one aspect, the HMD 120 includes the sensor 190 instead of, or in addition to, the HMD sensor 410 as a position detector. In at least one aspect, the HMD 120 uses the sensor 190 to detect the position and the inclination of the HMD 120. For example, in at least one embodiment, when the sensor 190 is an angular velocity sensor, a geomagnetic sensor, or an acceleration sensor, the HMD 120 uses any or all of those sensors instead of (or in addition to) the HMD sensor 410 to detect the position and the inclination of the HMD 120. As an example, when the sensor 190 is an angular velocity sensor, the angular velocity sensor detects over time the angular velocity about each of three axes of the HMD 120 in the real space. The HMD 120 calculates a temporal change of the angle about each of the three axes of the HMD 120 based on each angular velocity, and further calculates an inclination of the HMD 120 based on the temporal change of the angles.

The eye gaze sensor 140 detects a direction in which the lines of sight of the right eye and the left eye of the user 5 are directed. That is, the eye gaze sensor 140 detects the line of sight of the user 5. The direction of the line of sight is detectedby, for example, a known eye tracking function. The eye gaze sensor 140 is implemented by a sensor having the eye tracking function. In at least one aspect, the eye gaze sensor 140 includes a right-eye sensor and a left-eye sensor. In at least one embodiment, the eye gaze sensor 140 is, for example, a sensor configured to irradiate the right eye and the left eye of the user 5 with an infrared ray, and to receive reflection light from the cornea and the iris with respect to the irradiation light, to thereby detect a rotational angle of each of the user's 5 eyeballs. In at least one embodiment, the eye gaze sensor 140 detects the line of sight of the user 5 based on each detected rotational angle.

The first camera 150 photographs a lower part of a face of the user 5. More specifically, the first camera 150 photographs, for example, the nose or mouth of the user 5. The second camera 160 photographs, for example, the eyes and eyebrows of the user 5. A side of a casing of the HMD 120 on the user 5 side is defined as an interior side of the HMD 120, and a side of the casing of the HMD 120 on a side opposite to the user 5 side is defined as an exterior side of the HMD 120. In at least one aspect, the first camera 150 is arranged on an exterior side of the HMD 120, and the second camera 160 is arranged on an interior side of the HMD 120. Images generated by the first camera 150 and the second camera 160 are input to the computer 200. In at least one aspect, the first camera 150 and the second camera 160 are implemented as a single camera, and the face of the user 5 is photographed with this single camera.

The microphone 170 converts an utterance of the user 5 into a voice signal (electric signal) for output to the computer 200. The speaker 180 converts the voice signal into a voice for output to the user 5. In at least one embodiment, the speaker 180 converts other signals into audio information provided to the user 5. In at least one aspect, the HMD 120 includes earphones in place of the speaker 180.

The controller 300 is connected to the computer 200 through wired or wireless communication. The controller 300 receives input of a command from the user 5 to the computer 200. In at least one aspect, the controller 300 is held by the user 5. In at least one aspect, the controller 300 is mountable to the body or a part of the clothes of the user 5. In at least one aspect, the controller 300 is configured to output at least any one of a vibration, a sound, or light based on the signal transmitted from the computer 200. In at least one aspect, the controller 300 receives from the user 5 an operation for controlling the position and the motion of an object arranged in the virtual space.

In at least one aspect, the controller 300 includes a plurality of light sources. Each light source is implemented by, for example, an LED configured to emit an infrared ray. The HMD sensor 410 has a position tracking function. In this case, the HMD sensor 410 reads a plurality of infrared rays emitted by the controller 300 to detect the position and the inclination of the controller 300 in the real space. In at least one aspect, the HMD sensor 410 is implemented by a camera. In this case, the HMD sensor 410 uses image information of the controller 300 output from the camera to execute image analysis processing, to thereby enable detection of the position and the inclination of the controller 300.

In at least one aspect, the motion sensor 420 is mountable on the hand of the user 5 to detect the motion of the hand of the user 5. For example, the motion sensor 420 detects a rotational speed, a rotation angle, and the number of rotations of the hand. The detected signal is transmitted to the computer 200. The motion sensor 420 is provided to, for example, the controller 300. In at least one aspect, the motion sensor 420 is provided to, for example, the controller 300 capable of being held by the user 5. In at least one aspect, to help prevent accidently release of the controller 300 in the real space, the controller 300 is mountable on an object like a glove-type object that does not easily fly away by being worn on a hand of the user 5. In at least one aspect, a sensor that is not mountable on the user 5 detects the motion of the hand of the user 5. For example, a signal of a camera that photographs the user 5 may be input to the computer 200 as a signal representing the motion of the user 5. As at least one example, the motion sensor 420 and the computer 200 are connected to each other through wired or wireless communication. In the case of wireless communication, the communication mode is not particularly limited, and for example, Bluetooth (trademark) or other known communication methods are usable.

The display 430 displays an image similar to an image displayed on the monitor 130. With this, a user other than the user 5 wearing the HMD 120 can also view an image similar to that of the user 5. An image to be displayed on the display 430 is not required to be a three-dimensional image, but may be a right-eye image or a left-eye image. For example, a liquid crystal display or an organic EL monitor may be used as the display 430.

In at least one embodiment, the server 600 transmits a program to the computer 200. In at least one aspect, the server 600 communicates to/from another computer 200 for providing virtual reality to the HMD 120 used by another user. For example, when a plurality of users play a participatory game, for example, in an amusement facility, each computer 200 communicates to/from another computer 200 via the server 600 with a signal that is based on the motion of each user, to thereby enable the plurality of users to enjoy a common game in the same virtual space. Each computer 200 may communicate to/from another computer 200 with the signal that is based on the motion of each user without intervention of the server 600.

The external device 700 is any suitable device as long as the external device 700 is capable of communicating to/from the computer 200. The external device 700 is, for example, a device capable of communicating to/from the computer 200 via the network 2, or is a device capable of directly communicating to/from the computer 200 by near field communication or wired communication. Peripheral devices such as a smart device, a personal computer (PC), or the computer 200 are usable as the external device 700, in at least one embodiment, but the external device 700 is not limited thereto.

[Hardware Configuration of Computer]

With reference to FIG. 2, the computer 200 in at least one embodiment is described. FIG. 2 is a block diagram of a hardware configuration of the computer 200 according to at least one embodiment. The computer 200 includes, a processor 210, a memory 220, a storage 230, an input/output interface 240, and a communication interface 250. Each component is connected to a bus 260. In at least one embodiment, at least one of the processor 210, the memory 220, the storage 230, the input/output interface 240 or the communication interface 250 is part of a separate structure and communicates with other components of computer 200 through a communication path other than the bus 260.

The processor 210 executes a series of commands included in a program stored in the memory 220 or the storage 230 based on a signal transmitted to the computer 200 or in response to a condition determined in advance. In at least one aspect, the processor 210 is implemented as a central processing unit (CPU), a graphics processing unit (GPU), a micro-processor unit (MPU), a field-programmable gate array (FPGA), or other devices.

The memory 220 temporarily stores programs and data. The programs are loaded from, for example, the storage 230. The data includes data input to the computer 200 and data generated by the processor 210. In at least one aspect, the memory 220 is implemented as a random access memory (RAM) or other volatile memories.

The storage 230 permanently stores programs and data. In at least one embodiment, the storage 230 stores programs and data for a period of time longer than the memory 220, but not permanently. The storage 230 is implemented as, for example, a read-only memory (ROM), a hard disk device, a flash memory, or other non-volatile storage devices. The programs stored in the storage 230 include programs for providing a virtual space in the system 100, simulation programs, game programs, user authentication programs, and programs for implementing communication to/from other computers 200. The data stored in the storage 230 includes data and objects for defining the virtual space.

In at least one aspect, the storage 230 is implemented as a removable storage device like a memory card. In at least one aspect, a configuration that uses programs and data stored in an external storage device is used instead of the storage 230 built into the computer 200. With such a configuration, for example, in a situation in which a plurality of HMD systems 100 are used, for example in an amusement facility, the programs and the data are collectively updated.

The input/output interface 240 allows communication of signals among the HMD 120, the HMD sensor 410, the motion sensor 420, and the display 430. The monitor 130, the eye gaze sensor 140, the first camera 150, the second camera 160, the microphone 170, and the speaker 180 included in the HMD 120 may communicate to/from the computer 200 via the input/output interface 240 of the HMD 120. In at least one aspect, the input/output interface 240 is implemented with use of a universal serial bus (USB), a digital visual interface (DVI), a high-definition multimedia interface (HDMI) (trademark), or other terminals. The input/output interface 240 is not limited to the specific examples described above.

In at least one aspect, the input/output interface 240 further communicates to/from the controller 300. For example, the input/output interface 240 receives input of a signal output from the controller 300 and the motion sensor 420. In at least one aspect, the input/output interface 240 transmits a command output from the processor 210 to the controller 300. The command instructs the controller 300 to, for example, vibrate, output a sound, or emit light. When the controller 300 receives the command, the controller 300 executes any one of vibration, sound output, and light emission in accordance with the command.

The communication interface 250 is connected to the network 2 to communicate to/from other computers (e.g., server 600) connected to the network 2. In at least one aspect, the communication interface 250 is implemented as, for example, a local area network (LAN), other wired communication interfaces, wireless fidelity (Wi-Fi), Bluetooth (R), near field communication (NFC), or other wireless communication interfaces. The communication interface 250 is not limited to the specific examples described above.

In at least one aspect, the processor 210 accesses the storage 230 and loads one or more programs stored in the storage 230 to the memory 220 to execute a series of commands included in the program. In at least one embodiment, the one or more programs includes an operating system of the computer 200, an application program for providing a virtual space, and/or game software that is executable in the virtual space. The processor 210 transmits a signal for providing a virtual space to the HMD 120 via the input/output interface 240. The HMD 120 displays a video on the monitor 130 based on the signal.

In FIG. 2, the computer 200 is outside of the HMD 120, but in at least one aspect, the computer 200 is integral with the HMD 120. As an example, a portable information communication terminal (e.g., smartphone) including the monitor 130 functions as the computer 200 in at least one embodiment.

In at least one embodiment, the computer 200 is used in common with a plurality of HMDs 120. With such a configuration, for example, the computer 200 is able to provide the same virtual space to a plurality of users, and hence each user can enjoy the same application with other users in the same virtual space.

According to at least one embodiment of this disclosure, in the system 100, a real coordinate system is set in advance. The real coordinate system is a coordinate system in the real space. The real coordinate system has three reference directions (axes) that are respectively parallel to a vertical direction, a horizontal direction orthogonal to the vertical direction, and a front-rear direction orthogonal to both of the vertical direction and the horizontal direction in the real space. The horizontal direction, the vertical direction (up-down direction), and the front-rear direction in the real coordinate system are defined as an x axis, a y axis, and a z axis, respectively. More specifically, the x axis of the real coordinate system is parallel to the horizontal direction of the real space, the y axis thereof is parallel to the vertical direction of the real space, and the z axis thereof is parallel to the front-rear direction of the real space.

In at least one aspect, the HMD sensor 410 includes an infrared sensor. When the infrared sensor detects the infrared ray emitted from each light source of the HMD 120, the infrared sensor detects the presence of the HMD 120. The HMD sensor 410 further detects the position and the inclination (direction) of the HMD 120 in the real space, which corresponds to the motion of the user 5 wearing the HMD 120, based on the value of each point (each coordinate value in the real coordinate system). In more detail, the HMD sensor 410 is able to detect the temporal change of the position and the inclination of the HMD 120 with use of each value detected over time.

Each inclination of the HMD 120 detected by the HMD sensor 410 corresponds to an inclination about each of the three axes of the HMD 120 in the real coordinate system. The HMD sensor 410 sets a uvw visual-field coordinate system to the HMD 120 based on the inclination of the HMD 120 in the real coordinate system. The uvw visual-field coordinate system set to the HMD 120 corresponds to a point-of-view coordinate system used when the user 5 wearing the HMD 120 views an object in the virtual space.

[Uvw Visual-Field Coordinate System]

With reference to FIG. 3, the uvw visual-field coordinate system is described. FIG. 3 is a diagram of a uvw visual-field coordinate system to be set for the HMD 120 according to at least one embodiment of this disclosure. The HMD sensor 410 detects the position and the inclination of the HMD 120 in the real coordinate system when the HMD 120 is activated. The processor 210 sets the uvwvisual-field coordinate systemto the HMD 120 based on the detected values.

In FIG. 3, the HMD 120 sets the three-dimensional uvw visual-field coordinate system defining the head of the user 5 wearing the HMD 120 as a center (origin). More specifically, the HMD 120 sets three directions newly obtained by inclining the horizontal direction, the vertical direction, and the front-rear direction (x axis, y axis, and z axis), which define the real coordinate system, about the respective axes by the inclinations about the respective axes of the HMD 120 in the real coordinate system, as a pitch axis (u axis), a yaw axis (v axis), and a roll axis (w axis) of the uvw visual-field coordinate system in the HMD 120.

In at least one aspect, when the user 5 wearing the HMD 120 is standing (or sitting) upright and is visually recognizing the front side, the processor 210 sets the uvw visual-field coordinate system that is parallel to the real coordinate system to the HMD 120. In this case, the horizontal direction (x axis), the vertical direction (y axis), and the front-rear direction (z axis) of the real coordinate system directly match the pitch axis (u axis), the yaw axis (v axis), and the roll axis (w axis) of the uvw visual-field coordinate system in the HMD 120, respectively.

After the uvw visual-field coordinate system is set to the HMD 120, the HMD sensor 410 is able to detect the inclination of the HMD 120 in the set uvw visual-field coordinate system based on the motion of the HMD 120. In this case, the HMD sensor 410 detects, as the inclination of the HMD 120, each of a pitch angle (θu), a yaw angle (θv), and a roll angle (θw) of the HMD 120 in the uvw visual-field coordinate system. The pitch angle (θu) represents an inclination angle of the HMD 120 about the pitch axis in the uvw visual-field coordinate system. The yaw angle (θv) represents an inclination angle of the HMD 120 about the yaw axis in the uvw visual-field coordinate system. The roll angle (θw) represents an inclination angle of the HMD 120 about the roll axis in the uvw visual-field coordinate system.

The HMD sensor 410 sets, to the HMD 120, the uvw visual-field coordinate system of the HMD 120 obtained after the movement of the HMD 120 based on the detected inclination angle of the HMD 120. The relationship between the HMD 120 and the uvw visual-field coordinate system of the HMD 120 is constant regardless of the position and the inclination of the HMD 120. When the position and the inclination of the HMD 120 change, the position and the inclination of the uvw visual-field coordinate system of the HMD 120 in the real coordinate system change in synchronization with the change of the position and the inclination.

In at least one aspect, the HMD sensor 410 identifies the position of the HMD 120 in the real space as a position relative to the HMD sensor 410 based on the light intensity of the infrared ray or a relative positional relationship between a plurality of points (e.g., distance between points), which is acquired based on output from the infrared sensor. In at least one aspect, the processor 210 determines the origin of the uvw visual-field coordinate system of the HMD 120 in the real space (real coordinate system) based on the identified relative position.

[Virtual Space]

With reference to FIG. 4, the virtual space is further described. FIG. 4 is a diagram of a mode of expressing a virtual space 11 according to at least one embodiment of this disclosure. The virtual space 11 has a structure with an entire celestial sphere shape covering a center 12 in all 360-degree directions. In FIG. 4, for the sake of clarity, only the upper-half celestial sphere of the virtual space 11 is included. Each mesh section is defined in the virtual space 11. The position of each mesh section is defined in advance as coordinate values in an XYZ coordinate system, which is a global coordinate system defined in the virtual space 11. The computer 200 associates each partial image forming a panorama image 13 (e.g., still image or moving image) that is developed in the virtual space 11 with each corresponding mesh section in the virtual space 11.

In at least one aspect, in the virtual space 11, the XYZ coordinate system having the center 12 as the origin is defined. The XYZ coordinate system is, for example, parallel to the real coordinate system. The horizontal direction, the vertical direction (up-down direction), and the front-rear direction of the XYZ coordinate system are defined as an X axis, a Y axis, and a Z axis, respectively. Thus, the X axis (horizontal direction) of the XYZ coordinate system is parallel to the x axis of the real coordinate system, the Y axis (vertical direction) of the XYZ coordinate system is parallel to the y axis of the real coordinate system, and the Z axis (front-rear direction) of the XYZ coordinate system is parallel to the z axis of the real coordinate system.

When the HMD 120 is activated, that is, when the HMD 120 is in an initial state, a virtual camera 14 is arranged at the center 12 of the virtual space 11. In at least one embodiment, the virtual camera 14 is offset from the center 12 in the initial state. In at least one aspect, the processor 210 displays on the monitor 130 of the HMD 120 an image photographed by the virtual camera 14. In synchronization with the motion of the HMD 120 in the real space, the virtual camera 14 similarly moves in the virtual space 11. With this, the change in position and direction of the HMD 120 in the real space is reproduced similarly in the virtual space 11.

The uvw visual-field coordinate system is defined in the virtual camera 14 similarly to the case of the HMD 120. The uvw visual-field coordinate system of the virtual camera 14 in the virtual space 11 is defined to be synchronized with the uvw visual-field coordinate system of the HMD 120 in the real space (real coordinate system). Therefore, when the inclination of the HMD 120 changes, the inclination of the virtual camera 14 also changes in synchronization therewith. The virtual camera 14 can also move in the virtual space 11 in synchronization with the movement of the user 5 wearing the HMD 120 in the real space.

The processor 210 of the computer 200 defines a field-of-view region 15 in the virtual space 11 based on the position and inclination (reference line of sight 16) of the virtual camera 14. The field-of-view region 15 corresponds to, of the virtual space 11, the region that is visually recognized by the user 5 wearing the HMD 120. That is, the position of the virtual camera 14 determines a point of view of the user 5 in the virtual space 11.

The line of sight of the user 5 detected by the eye gaze sensor 140 is a direction in the point-of-view coordinate system obtained when the user 5 visually recognizes an object. The uvw visual-field coordinate system of the HMD 120 is equal to the point-of-view coordinate system used when the user 5 visually recognizes the monitor 130. The uvw visual-field coordinate system of the virtual camera 14 is synchronized with the uvw visual-field coordinate system of the HMD 120. Therefore, in the system 100 in at least one aspect, the line of sight of the user 5 detected by the eye gaze sensor 140 can be regarded as the line of sight of the user 5 in the uvw visual-field coordinate system of the virtual camera 14.

[User's Line of Sight]

With reference to FIG. 5, determination of the line of sight of the user 5 is described. FIG. 5 is a plan view diagram of the head of the user 5 wearing the HMD 120 according to at least one embodiment of this disclosure.

In at least one aspect, the eye gaze sensor 140 detects lines of sight of the right eye and the left eye of the user 5. In at least one aspect, when the user 5 is looking at a near place, the eye gaze sensor 140 detects lines of sight R1 and L1. In at least one aspect, when the user 5 is looking at a far place, the eye gaze sensor 140 detects lines of sight R2 and L2. In this case, the angles formed by the lines of sight R2 and L2 with respect to the roll axis w are smaller than the angles formed by the lines of sight R1 and L1 with respect to the roll axis w. The eye gaze sensor 140 transmits the detection results to the computer 200.

When the computer 200 receives the detection values of the lines of sight R1 and L1 from the eye gaze sensor 140 as the detection results of the lines of sight, the computer 200 identifies a point of gaze N1 being an intersection of both the lines of sight R1 and L1 based on the detection values. Meanwhile, when the computer 200 receives the detection values of the lines of sight R2 and L2 from the eye gaze sensor 140, the computer 200 identifies an intersection of both the lines of sight R2 and L2 as the point of gaze. The computer 200 identifies a line of sight N0 of the user 5 based on the identified point of gaze N1. The computer 200 detects, for example, an extension direction of a straight line that passes through the point of gaze N1 and a midpoint of a straight line connecting a right eye R and a left eye L of the user 5 to each other as the line of sight N0. The line of sight N0 is a direction in which the user 5 actually directs his or her lines of sight with both eyes. The line of sight N0 corresponds to a direction in which the user 5 actually directs his or her lines of sight with respect to the field-of-view region 15.

In at least one aspect, the system 100 includes a television broadcast reception tuner. With such a configuration, the system 100 is able to display a television program in the virtual space 11.

In at least one aspect, the HMD system 100 includes a communication circuit for connecting to the Internet or has a verbal communication function for connecting to a telephone line or a cellular service.

[Field-of-View Region]

With reference to FIG. 6 and FIG. 7, the field-of-view region 15 is described. FIG. 6 is a diagram of a YZ cross section obtained by viewing the field-of-view region 15 from an X direction in the virtual space 11. FIG. 7 is a diagram of an XZ cross section obtained by viewing the field-of-view region 15 from a Y direction in the virtual space 11.

In FIG. 6, the field-of-view region 15 in the YZ cross section includes a region 18. The region 18 is defined by the position of the virtual camera 14, the reference line of sight 16, and the YZ cross section of the virtual space 11. The processor 210 defines a range of a polar angle a from the reference line of sight 16 serving as the center in the virtual space as the region 18.

In FIG. 7, the field-of-view region 15 in the XZ cross section includes a region 19. The region 19 is defined by the position of the virtual camera 14, the reference line of sight 16, and the XZ cross section of the virtual space 11. The processor 210 defines a range of an azimuth β from the reference line of sight 16 serving as the center in the virtual space 11 as the region 19. The polar angle aα and β are determined in accordance with the position of the virtual camera 14 and the inclination (direction) of the virtual camera 14.

In at least one aspect, the system 100 causes the monitor 130 to display a field-of-view image 17 based on the signal from the computer 200, to thereby provide the field of view in the virtual space 11 to the user 5. The field-of-view image 17 corresponds to a part of the panorama image 13, which corresponds to the field-of-view region 15. When the user 5 moves the HMD 120 worn on his or her head, the virtual camera 14 is also moved in synchronization with the movement. As a result, the position of the field-of-view region 15 in the virtual space 11 is changed. With this, the field-of-view image 17 displayed on the monitor 130 is updated to an image of the panorama image 13, which is superimposed on the field-of-view region 15 synchronized with a direction in which the user 5 faces in the virtual space 11. The user 5 can visually recognize a desired direction in the virtual space 11.

In this way, the inclination of the virtual camera 14 corresponds to the line of sight of the user 5 (reference line of sight 16) in the virtual space 11, and the position at which the virtual camera 14 is arranged corresponds to the point of view of the user 5 in the virtual space 11. Therefore, through the change of the position or inclination of the virtual camera 14, the image to be displayed on the monitor 130 is updated, and the field of view of the user 5 is moved.

While the user 5 is wearing the HMD 120 (having a non-transmissive monitor 130), the user 5 can visually recognize only the panorama image 13 developed in the virtual space 11 without visually recognizing the real world. Therefore, the system 100 provides a high sense of immersion in the virtual space 11 to the user 5.

In at least one aspect, the processor 210 moves the virtual camera 14 in the virtual space 11 in synchronization with the movement in the real space of the user 5 wearing the HMD 120. In this case, the processor 210 identifies an image region to be projected on the monitor 130 of the HMD 120 (field-of-view region 15) based on the position and the direction of the virtual camera 14 in the virtual space 11.

In at least one aspect, the virtual camera 14 includes two virtual cameras, that is, a virtual camera for providing a right-eye image and a virtual camera for providing a left-eye image. An appropriate parallax is set for the two virtual cameras so that the user 5 is able to recognize the three-dimensional virtual space 11. In at least one aspect, the virtual camera 14 is implemented by a single virtual camera. In this case, a right-eye image and a left-eye image may be generated from an image acquired by the single virtual camera. In at least one embodiment, the virtual camera 14 is assumed to include two virtual cameras, and the roll axes of the two virtual cameras are synthesized so that the generated roll axis (w) is adapted to the roll axis (w) of the HMD 120.

[Controller]

An example of the controller 300 is described with reference to FIG. 8A and FIG. 8B. FIG. 8A is a diagram of a schematic configuration of a controller according to at least one embodiment of this disclosure. FIG. 8B is a diagram of a coordinate system to be set for a hand of a user holding the controller according to at least one embodiment of this disclosure.

In at least one aspect, the controller 300 includes a right controller 300R and a left controller (not shown). In FIG. 8A only right controller 300R is shown for the sake of clarity. The right controller 300R is operable by the right hand of the user 5. The left controller is operable by the left hand of the user 5. In at least one aspect, the right controller 300R and the left controller are symmetrically configured as separate devices. Therefore, the user 5 can freely move his or her right hand holding the right controller 300R and his or her left hand holding the left controller. In at least one aspect, the controller 300 may be an integrated controller configured to receive an operation performed by both the right and left hands of the user 5. The right controller 300R is now described.

The right controller 300R includes a grip 310, a frame 320, and a top surface 330. The grip 310 is configured so as to be held by the right hand of the user 5. For example, the grip 310 may be held by the palm and three fingers (e.g., middle finger, ring finger, and small finger) of the right hand of the user 5.

The grip 310 includes buttons 340 and 350 and the motion sensor 420. The button 340 is arranged on a side surface of the grip 310, and receives an operation performed by, for example, the middle finger of the right hand. The button 350 is arranged on a front surface of the grip 310, and receives an operation performed by, for example, the index finger of the right hand. In at least one aspect, the buttons 340 and 350 are configured as trigger type buttons. The motion sensor 420 is built into the casing of the grip 310. When a motion of the user 5 can be detected from the surroundings of the user 5 by a camera or other device. In at least one embodiment, the grip 310 does not include the motion sensor 420.

The frame 320 includes a plurality of infrared LEDs 360 arranged in a circumferential direction of the frame 320. The infrared LEDs 360 emit, during execution of a program using the controller 300, infrared rays in accordance with progress of the program. The infrared rays emitted from the infrared LEDs 360 are usable to independently detect the position and the posture (inclination and direction) of each of the right controller 300R andthe left controller. In FIG. 8A, the infrared LEDs 360 are shown as being arranged in two rows, but the number of arrangement rows is not limited to that illustrated in FIGS. 8. In at least one embodiment, the infrared LEDs 360 are arranged in one row or in three or more rows. In at least one embodiment, the infrared LEDs 360 are arranged in a pattern other than rows.

The top surface 330 includes buttons 370 and 380 and an analog stick 390. The buttons 370 and 380 are configured as push type buttons. The buttons 370 and 380 receive an operation performed by the thumb of the right hand of the user 5. In at least one aspect, the analog stick 390 receives an operation performed in any direction of 360 degrees from an initial position (neutral position). The operation includes, for example, an operation for moving an object arranged in the virtual space 11.

In at least one aspect, each of the right controller 300R and the left controller includes a battery for driving the infrared ray LEDs 360 and other members. The battery includes, for example, a rechargeable battery, a button battery, a dry battery, but the battery is not limited thereto. In at least one aspect, the right controller 300R and the left controller are connectable to, for example, a USB interface of the computer 200. In at least one embodiment, the right controller 300R and the left controller do not include a battery.

In FIG. 8A and FIG. 8B, for example, a yaw direction, a roll direction, and a pitch direction are defined with respect to the right hand of the user 5. A direction of an extended thumb is defined as the yaw direction, a direction of an extended index finger is defined as the roll direction, and a direction perpendicular to a plane is defined as the pitch direction.

[Hardware Configuration of Server]

With reference to FIG. 9, the server 600 in at least one embodiment is described. FIG. 9 is a block diagram of a hardware configuration of the server 600 according to at least one embodiment of this disclosure. The server 600 includes a processor 610, a memory 620, a storage 630, an input/output interface 640, and a communication interface 650. Each component is connected to a bus 660. In at least one embodiment, at least one of the processor 610, the memory 620, the storage 630, the input/output interface 640 or the communication interface 650 is part of a separate structure and communicates with other components of server 600 through a communication path other than the bus 660.

The processor 610 executes a series of commands included in a program stored in the memory 620 or the storage 630 based on a signal transmitted to the server 600 or on satisfaction of a condition determined in advance. In at least one aspect, the processor 610 is implemented as a central processing unit (CPU), a graphics processing unit (GPU), a micro processing unit (MPU), a field-programmable gate array (FPGA), or other devices.

The memory 620 temporarily stores programs and data. The programs are loaded from, for example, the storage 630. The data includes data input to the server 600 and data generated by the processor 610. In at least one aspect, the memory 620 is implemented as a random access memory (RAM) or other volatile memories.

The storage 630 permanently stores programs and data. In at least one embodiment, the storage 630 stores programs and data for a period of time longer than the memory 620, but not permanently. The storage 630 is implemented as, for example, a read-only memory (ROM), a hard disk device, a flash memory, or other non-volatile storage devices. The programs stored in the storage 630 include programs for providing a virtual space in the system 100, simulation programs, game programs, user authentication programs, and programs for implementing communication to/from other computers 200 or servers 600. The data stored in the storage 630 may include, for example, data and objects for defining the virtual space.

In at least one aspect, the storage 630 is implemented as a removable storage device like a memory card. In at least one aspect, a configuration that uses programs and data stored in an external storage device is used instead of the storage 630 built into the server 600. With such a configuration, for example, in a situation in which a plurality of HMD systems 100 are used, for example, as in an amusement facility, the programs and the data are collectively updated.

The input/output interface 640 allows communication of signals to/from an input/output device. In at least one aspect, the input/output interface 640 is implemented with use of a USB, a DVI, an HDMI, or other terminals. The input/output interface 640 is not limited to the specific examples described above.

The communication interface 650 is connected to the network 2 to communicate to/from the computer 200 connected to the network 2. In at least one aspect, the communication interface 650 is implemented as, for example, a LAN, other wired communication interfaces, Wi-Fi, Bluetooth, NFC, or other wireless communication interfaces. The communication interface 650 is not limited to the specific examples described above.

In at least one aspect, the processor 610 accesses the storage 630 and loads one or more programs stored in the storage 630 to the memory 620 to execute a series of commands included in the program. In at least one embodiment, the one or more programs include, for example, an operating system of the server 600, an application program for providing a virtual space, and game software that can be executed in the virtual space. In at least one embodiment, the processor 610 transmits a signal for providing a virtual space to the HMD device 110 to the computer 200 via the input/output interface 640.

[Control Device of HMD]

With reference to FIG. 10, the control device of the HMD 120 is described. According to at least one embodiment of this disclosure, the control device is implemented by the computer 200 having a known configuration. FIG. 10 is a block diagram of the computer 200 according to at least one embodiment of this disclosure. FIG. 10 includes a module configuration of the computer 200.

In FIG. 10, the computer 200 includes a control module 510, a rendering module 520, a memory module 530, and a communication control module 540. In at least one aspect, the control module 510 and the rendering module 520 are implemented by the processor 210. In at least one aspect, a plurality of processors 210 function as the control module 510 and the rendering module 520. The memory module 530 is implemented by the memory 220 or the storage 230. The communication control module 540 is implemented by the communication interface 250.

The control module 510 controls the virtual space 11 provided to the user 5. The control module 510 defines the virtual space 11 in the HMD system 100 using virtual space data representing the virtual space 11. The virtual space data is stored in, for example, the memory module 530. In at least one embodiment, the control module 510 generates virtual space data. In at least one embodiment, the control module 510 acquires virtual space data from, for example, the server 600.

The control module 510 arranges objects in the virtual space 11 using object data representing objects. The object data is stored in, for example, the memory module 530. In at least one embodiment, the control module 510 generates virtual space data. In at least one embodiment, the control module 510 acquires virtual space data from, for example, the server 600. In at least one embodiment, the objects include, for example, an avatar object of the user 5, character objects, operation objects, for example, a virtual hand to be operated by the controller 300, and forests, mountains, other landscapes, streetscapes, or animals to be arranged in accordance with the progression of the story of the game.

The control module 510 arranges an avatar object of the user 5 of another computer 200, which is connected via the network 2, in the virtual space 11. In at least one aspect, the control module 510 arranges an avatar object of the user 5 in the virtual space 11. In at least one aspect, the control module 510 arranges an avatar object simulating the user 5 in the virtual space 11 based on an image including the user 5. In at least one aspect, the control module 510 arranges an avatar object in the virtual space 11, which is selected by the user 5 from among a plurality of types of avatar objects (e.g., objects simulating animals or objects of deformed humans).

The control module 510 identifies an inclination of the HMD 120 based on output of the HMD sensor 410. In at least one aspect, the control module 510 identifies an inclination of the HMD 120 based on output of the sensor 190 functioning as a motion sensor. The control module 510 detects parts (e.g., mouth, eyes, and eyebrows) forming the face of the user 5 from a face image of the user 5 generated by the first camera 150 and the second camera 160. The control module 510 detects a motion (shape) of each detected part.

The control module 510 detects a line of sight of the user 5 in the virtual space 11 based on a signal from the eye gaze sensor 140. The control module 510 detects a point-of-view position (coordinate values in the XYZ coordinate system) at which the detected line of sight of the user 5 and the celestial sphere of the virtual space 11 intersect with each other. More specifically, the control module 510 detects the point-of-view position based on the line of sight of the user 5 defined in the uvw coordinate system and the position and the inclination of the virtual camera 14. The control module 510 transmits the detected point-of-view position to the server 600. In at least one aspect, the control module 510 is configured to transmit line-of-sight information representing the line of sight of the user 5 to the server 600. In such a case, the control module 510 may calculate the point-of-view position based on the line-of-sight information received by the server 600.

The control module 510 translates a motion of the HMD 120, which is detected by the HMD sensor 410, in an avatar object. For example, the control module 510 detects inclination of the HMD 120, and arranges the avatar object in an inclined manner. The control module 510 translates the detected motion of face parts in a face of the avatar object arranged in the virtual space 11. The control module 510 receives line-of-sight information of another user 5 from the server 600, and translates the line-of-sight information in the line of sight of the avatar object of another user 5. In at least one aspect, the control module 510 translates a motion of the controller 300 in an avatar object and an operation object. In this case, the controller 300 includes, for example, a motion sensor, an acceleration sensor, or a plurality of light emitting elements (e.g., infrared LEDs) for detecting a motion of the controller 300.

The control module 510 arranges, in the virtual space 11, an operation object for receiving an operation by the user 5 in the virtual space 11. The user 5 operates the operation object to, for example, operate an object arranged in the virtual space 11. In at least one aspect, the operation object includes, for example, a hand object serving as a virtual hand corresponding to a hand of the user 5. In at least one aspect, the control module 510 moves the hand object in the virtual space 11 so that the hand object moves in association with a motion of the hand of the user 5 in the real space based on output of the motion sensor 420. In at least one aspect, the operation object may correspond to a hand part of an avatar object.

When one object arranged in the virtual space 11 collides with another object, the control module 510 detects the collision. The control module 510 is able to detect, for example, a timing at which a collision area of one object and a collision area of another object have touched with each other, and performs predetermined processing in response to the detected timing. In at least one embodiment, the control module 510 detects a timing at which an object and another object, which have been in contact with each other, have moved away from each other, and performs predetermined processing in response to the detected timing. In at least one embodiment, the control module 510 detects a state in which an object and another object are in contact with each other. For example, when an operation object touches another object, the control module 510 detects the fact that the operation object has touched the other object, and performs predetermined processing.

In at least one aspect, the control module 510 controls image display of the HMD 120 on the monitor 130. For example, the control module 510 arranges the virtual camera 14 in the virtual space 11. The control module 510 controls the position of the virtual camera 14 and the inclination (direction) of the virtual camera 14 in the virtual space 11. The control module 510 defines the field-of-view region 15 depending on an inclination of the head of the user 5 wearing the HMD 120 and the position of the virtual camera 14. The rendering module 520 generates the field-of-view region 17 to be displayed on the monitor 130 based on the determined field-of-view region 15. The communication control module 540 outputs the field-of-view region 17 generated by the rendering module 520 to the HMD 120.

The control module 510, which has detected an utterance of the user 5 using the microphone 170 from the HMD 120, identifies the computer 200 to which voice data corresponding to the utterance is to be transmitted. The voice data is transmitted to the computer 200 identified by the control module 510. The control module 510, which has received voice data from the computer 200 of another user via the network 2, outputs audio information (utterances) corresponding to the voice data from the speaker 180.

The memory module 530 holds data to be used to provide the virtual space 11 to the user 5 by the computer 200. In at least one aspect, the memory module 530 stores space information, object information, and user information.

The space information stores one or more templates defined to provide the virtual space 11.

The object information stores a plurality of panorama images 13 forming the virtual space 11 and object data for arranging objects in the virtual space 11. In at least one embodiment, the panorama image 13 contains a still image and/or a moving image. In at least one embodiment, the panorama image 13 contains an image in a non-real space and/or an image in the real space. An example of the image in a non-real space is an image generated by computer graphics.

The user information stores a user ID for identifying the user 5. The user ID is, for example, an internet protocol (IP) address or a media access control (MAC) address set to the computer 200 used by the user. In at least one aspect, the user ID is set by the user. The user information stores, for example, a program for causing the computer 200 to function as the control device of the HMD system 100.

The data and programs stored in the memory module 530 are input by the user 5 of the HMD 120. Alternatively, the processor 210 downloads the programs or data from a computer (e.g., server 600) that is managed by a business operator providing the content, and stores the downloaded programs or data in the memory module 530.

In at least one embodiment, the communication control module 540 communicates to/from the server 600 or other information communication devices via the network 2.

In at least one aspect, the control module 510 and the rendering module 520 are implementedwith use of, for example, Unity (R) provided by Unity Technologies. In at least one aspect, the control module 510 and the rendering module 520 are implemented by combining the circuit elements for implementing each step of processing.

The processing performed in the computer 200 is implemented by hardware and software executed by the processor 410. In at least one embodiment, the software is stored in advance on a hard disk or other memory module 530. In at least one embodiment, the software is stored on a CD-ROM or other computer-readable non-volatile data recording media, and distributed as a program product. In at least one embodiment, the software may is provided as a program product that is downloadable by an information provider connected to the Internet or other networks. Such software is read from the data recording medium by an optical disc drive device or other data reading devices, or is downloaded from the server 600 or other computers via the communication control module 540 and then temporarily stored in a storage module. The software is read from the storage module by the processor 210, and is stored in a RAM in a format of an executable program. The processor 210 executes the program.

[Control Structure of HMD System]

With reference to FIG. 11, the control structure of the HMD set 110 is described. FIG. 11 is a sequence chart of processing to be executed by the system 100 according to at least one embodiment of this disclosure.

In FIG. 11, in Step S1110, the processor 210 of the computer 200 serves as the control module 510 to identify virtual space data and define the virtual space 11.

In Step S1120, the processor 210 initializes the virtual camera 14. For example, in a work area of the memory, the processor 210 arranges the virtual camera 14 at the center 12 defined in advance in the virtual space 11, and matches the line of sight of the virtual camera 14 with the direction in which the user 5 faces.

In Step S1130, the processor 210 serves as the rendering module 520 to generate field-of-view image data for displaying an initial field-of-view image. The generated field-of-view image data is output to the HMD 120 by the communication control module 540.

In Step S1132, the monitor 130 of the HMD 120 displays the field-of-view image based on the field-of-view image data received from the computer 200. The user 5 wearing the HMD 120 is able to recognize the virtual space 11 through visual recognition of the field-of-view image.

In Step S1134, the HMD sensor 410 detects the position and the inclination of the HMD 120 based on a plurality of infrared rays emitted from the HMD 120. The detection results are output to the computer 200 as motion detection data.

In Step S1140, the processor 210 identifies a field-of-view direction of the user 5 wearing the HMD 120 based on the position and inclination contained in the motion detection data of the HMD 120.

In Step S1150, the processor 210 executes an application program, and arranges an object in the virtual space 11 based on a command contained in the application program.

In Step S1160, the controller 300 detects an operation by the user 5 based on a signal output from the motion sensor 420, and outputs detection data representing the detected operation to the computer 200. In at least one aspect, an operation of the controller 300 by the user 5 is detected based on an image from a camera arranged around the user 5.

In Step S1170, the processor 210 detects an operation of the controller 300 by the user 5 based on the detection data acquired from the controller 300.

In Step S1180, the processor 210 generates field-of-view image data based on the operation of the controller 300 by the user 5. The communication control module 540 outputs the generated field-of-view image data to the HMD 120.

In Step S1190, the HMD 120 updates a field-of-view image based on the received field-of-view image data, and displays the updated field-of-view image on the monitor 130.

[Avatar Object]

With reference to FIG. 12A and FIG. 12B, an avatar object according to at least one embodiment is described. FIG. 12 and FIG. 12B are diagrams of avatar objects of respective users 5 of the HMD sets 110A and 110B. In the following, the user of the HMD set 110A, the user of the HMD set 110B, the user of the HMD set 110C, and the user of the HMD set 110D are referred to as “user 5A”, “user 5B”, “user 5C”, and “user 5D”, respectively. A reference numeral of each component related to the HMD set 110A, a reference numeral of each component related to the HMD set 110B, a reference numeral of each component related to the HMD set 110C, and a reference numeral of each component related to the HMD set 110D are appended by A, B, C, and D, respectively. For example, the HMD 120A is included in the HMD set 110A.

FIG. 12A is a schematic diagram of HMD systems of several users sharing the virtual space interact using a network according to at least one embodiment of this disclosure. Each HMD 120 provides the user 5 with the virtual space 11. Computers 200A to 200D provide the users 5A to 5D with virtual spaces 11A to 11D via HMDs 120A to 120D, respectively. In FIG. 12A, the virtual space 11A and the virtual space 11B are formed by the same data. In other words, the computer 200A and the computer 200B share the same virtual space. An avatar object 6A of the user 5A and an avatar object 6B of the user 5B are present in the virtual space 11A and the virtual space 11B. The avatar object 6A in the virtual space 11A and the avatar object 6B in the virtual space 11B each wear the HMD 120. However, the inclusion of the HMD 120A and HMD 120B is only for the sake of simplicity of description, and the avatars do not wear the HMD 120A and HMD 120B in the virtual spaces 11A and 11B, respectively.

In at least one aspect, the processor 210A arranges a virtual camera 14A for photographing a field-of-view region 17A of the user 5A at the position of eyes of the avatar object 6A.

FIG. 12B is a diagram of a field of view of a HMD according to at least one embodiment of this disclosure. FIG. 12(B) corresponds to the field-of-view region 17A of the user 5A in FIG. 12A. The field-of-view region 17A is an image displayed on a monitor 130A of the HMD 120A. This field-of-view region 17A is an image generated by the virtual camera 14A. The avatar object 6B of the user 5B is displayed in the field-of-view region 17A. Although not included in FIG. 12B, the avatar object 6A of the user 5A is displayed in the field-of-view image of the user 5B.

In the arrangement in FIG. 12B, the user 5A can communicate to/from the user 5B via the virtual space 11A through conversation. More specifically, voices of the user 5A acquired by a microphone 170A are transmitted to the HMD 120B of the user 5B via the server 600 and output from a speaker 180B provided on the HMD 120B. Voices of the user 5B are transmitted to the HMD 120A of the user 5A via the server 600, and output from a speaker 180A provided on the HMD 120A.

The processor 210A translates an operation by the user 5B (operation of HMD 120B and operation of controller 300B) in the avatar object 6B arranged in the virtual space 11A. With this, the user 5A is able to recognize the operation by the user 5B through the avatar object 6B.

FIG. 13 is a sequence chart of processing to be executed by the system 100 according to at least one embodiment of this disclosure. In FIG. 13, although the HMD set 110D is not included, the HMD set 110D operates in a similar manner as the HMD sets 110A, 110B, and 110C. Also in the following description, a reference numeral of each component related to the HMD set 110A, a reference numeral of each component related to the HMD set 110B, a reference numeral of each component related to the HMD set 110C, and a reference numeral of each component related to the HMD set 110D are appended by A, B, C, and D, respectively.

In Step S1310A, the processor 210A of the HMD set 110A acquires avatar information for determining a motion of the avatar object 6A in the virtual space 11A. This avatar information contains information on an avatar such as motion information, face tracking data, and sound data. The motion information contains, for example, information on a temporal change in position and inclination of the HMD 120A and information on a motion of the hand of the user 5A, which is detected by, for example, a motion sensor 420A. An example of the face tracking data is data identifying the position and size of each part of the face of the user 5A. Another example of the face tracking data is data representing motions of parts forming the face of the user 5A and line-of-sight data. An example of the sound data is data representing sounds of the user 5A acquired by the microphone 170A of the HMD 120A. In at least one embodiment, the avatar information contains information identifying the avatar object 6A or the user 5A associated with the avatar object 6A or information identifying the virtual space 11A accommodating the avatar object 6A. An example of the information identifying the avatar object 6A or the user 5A is a user ID. An example of the information identifying the virtual space 11A accommodating the avatar object 6A is a room ID. The processor 210A transmits the avatar information acquired as described above to the server 600 via the network 2.

In Step S1310B, the processor 210B of the HMD set 110B acquires avatar information for determining a motion of the avatar object 6B in the virtual space 11B, and transmits the avatar information to the server 600, similarly to the processing of Step S1310A. Similarly, in Step S1310C, the processor 210C of the HMD set 110C acquires avatar information for determining a motion of the avatar object 6C in the virtual space 11C, and transmits the avatar information to the server 600.

In Step S1320, the server 600 temporarily stores pieces of player information received from the HMD set 110A, the HMD set 110B, and the HMD set 110C, respectively. The server 600 integrates pieces of avatar information of all the users (in this example, users 5A to 5C) associated with the common virtual space 11 based on, for example, the user IDs and room IDs contained in respective pieces of avatar information. Then, the server 600 transmits the integrated pieces of avatar information to all the users associated with the virtual space 11 at a timing determined in advance. In this manner, synchronization processing is executed. Such synchronization processing enables the HMD set 110A, the HMD set 110B, and the HMD 120C to share mutual avatar information at substantially the same timing.

Next, the HMD sets 110A to 110C execute processing of Step S1330A to Step S1330C, respectively, based on the integrated pieces of avatar information transmitted from the server 600 to the HMD sets 110A to 110C. The processing of Step S1330A corresponds to the processing of Step S1180 of FIG. 11.

In Step S1330A, the processor 210A of the HMD set 110A updates information on the avatar object 6B and the avatar object 6C of the other users 5B and 5C in the virtual space 11A. Specifically, the processor 210A updates, for example, the position and direction of the avatar object 6B in the virtual space 11 based on motion information contained in the avatar information transmitted from the HMD set 110B. For example, the processor 210A updates the information (e.g., position and direction) on the avatar object 6B contained in the object information stored in the memory module 530. Similarly, the processor 210A updates the information (e.g., position and direction) on the avatar object 6C in the virtual space 11 based on motion information contained in the avatar information transmitted from the HMD set 110C.

In Step S1330B, similarly to the processing of Step S1330A, the processor 210B of the HMD set 110B updates information on the avatar object 6A and the avatar object 6C of the users 5A and 5C in the virtual space 11B. Similarly, in Step S1330C, the processor 210C of the HMD set 110C updates information on the avatar object 6A and the avatar object 6B of the users 5A and 5B in the virtual space 11C.

With reference to FIG. 14, a module configuration of the computer 200 are described. FIG. 14 is a block diagram of a configuration of modules of the computer 200 according to at least one embodiment of this disclosure.

In FIG. 14, the control module 510 includes a virtual space identification module 1421, an HMD motion detection module 1422, a line-of-sight detection module 1423, a reference-line-of-sight determination module 1424, a field-of-view region determination module 1425, and a controller motion detection module 1426. The rendering module 520 includes a field-of-view image generation module 1428 and afield-of-view image output module 1429. The memory module 530 stores virtual space data 1431, object data 1432, application data 1433, and other data 1434. The memory module 530 may also include various data required for calculation to provide output information corresponding to inputs from the HMD sensor 410, the motion sensor 420, the eye gaze sensor 140, the controller 300, and the like to the monitor 130 associated with the HMD 120. The object data 1432 may include data relating to the operation objects, virtual objects, and the like to be arranged in the virtual space. The monitor 130 may be included in the HMD 120 or may be a display of another device (e.g., smartphone) attachable to the HMD 120.

FIG. 15 is a flowchart of processing for displaying on the monitor 130 an image of the virtual space in which the user is to be immersed according to at least one embodiment of this disclosure.

Processing by the HMD set 110 for providing an image of the virtual space is now described with reference to FIG. 14 and FIG. 15. The virtual space 11 may be provided by interaction among the HMD sensor 410, the eye gaze sensor 140, the computer 200, or the like.

The processing includes in Step 1502. As an example, a game application included in the application data may be executed by the computer 200. In Step 1504, the processor 210 (virtual space identification module 1421) generates a celestial panoramic image 13 forming the virtual space 11 in which the user is to be immersed by, for example, referring to the virtual space data 1431. The position and inclination of the HMD 120 are detected by the HMD sensor 410. The information detected by the HMD sensor 410 is transmitted to the computer 200. In Step 1506, the HMD motion detection module 1422 acquires position information and inclination informationontheHMD 120. In Step 1508, the field-of-viewdirection is determined based on the acquired position information and inclination information.

When the eye gaze sensor 140 detects a motion of each of the eyeballs of the left and right eyes of the user, information on the motion is transmitted to the computer 200. In Step 1510, the line-of-sight detection module 1423 identifies the direction in which the line of sight of each of the right eye and the left eye is directed, and determines a line-of-sight direction NO. In Step 1512, the reference-line-of-sight determination module 1424 determines the field-of-view direction determined by the inclination of the HMD 120 or the line-of-sight direction NO of the user as the reference line of sight 16. The reference line of sight 16 may also be determined based on the position of the HMD 120 and the position and inclination of the virtual camera 14 following the position and inclination of the HMD 120.

In Step 1514, the field-of-view region determination module 1425 determines the field-of-view region 15 of the virtual camera 14 in the virtual space 11. In FIG. 4, the field-of-view region 15 is, of the panorama image 13, a portion forming the field of view of the user. The field-of-view region 15 is determined based on the reference line of sight 16. In FIG. 6 and FIG. 7, which have already been described, there are a yz cross-sectional view of the field-of-view region 15 viewed from the x direction and an xz cross-sectional view of the field-of-view region 15 viewed from the y direction.

In Step 1516, the field-of-view image generation module 1428 generates a field-of-view image based on the field-of-view region 15. The field-of-view image includes a two-dimensional image for the right eye and a two-dimensional image for the left eye. Those two-dimensional images are superimposed on the monitor 130 (more specifically, the image for the right eye is output to a display for the right eye and the image for the left eye is output to a display for the left eye), and as a result, the virtual space 11 as a three-dimensional image is provided to the user. In Step 1518, the field-of-view image output module 1429 outputs information on the field-of-view image to the monitor 130. The monitor 130 displays the field-of-view image based on the received information on the field-of-view image.

FIG. 16 is a flowchart of a method 1600 according to at least one embodiment of this disclosure. In at least one embodiment of this disclosure, the computer program causes the processor 210 (or computer 200) to execute the steps of FIG. 16. At least one embodiment of this disclosure may be implementedby the processor 210 (or computer 200) executing the method 1600.

Embodiments of this disclosure are now specifically described. As a specific example to which the embodiments of this disclosure may be applied, there is described a game that may be enjoyed by a plurality of users immersing themselves in a virtual space in which the avatar of each user is arranged. However, the embodiments of this disclosure are not necessarily limited to such a mode. One of ordinary skill in the art would understand that the embodiments of this disclosure may take various modes that fall within the scope defined in the appended claims.

FIG. 17 is a schematic diagram of a mode of a game according to at least one embodiment of this disclosure. In at least this example, two users 5A and 5B (hereinafter collectively referred to as “user 5”) are playing a tennis game in a virtual space. One of ordinary skill in the art would understand that the tennis game is merely an example for describing at least one embodiment of this disclosure, and any other kind of game may be applied to the at least one embodiment. The users 5A and 5B each wear an HMD 120A or an HMD 120B (hereinafter collectively referred to as “HMD 120”) on their heads, and hold and operate a controller 300A and a controller 300B (hereinafter collectively referred to as “controller 300”). In at least one example, the controller 300 has the configuration described above regarding FIG. 8A and FIG. 8B.

In a virtual space 1711, there are arranged avatars 6A and 6B (hereinafter collectively referred to as “avatar 6”) to be operated by the users 5A and 5B, respectively, and a tennis court 1741 as a game field on which a tennis match is to be performed by the avatars 6A and 6B. The avatars 6A and 6B each hold a racket 8A or 8B (hereinafter collectively referred to as “racket 8”) in a hand 7A or 7B (hereinafter also collectively referred to as “hand 7”). The tennis court 1741 includes, for example, lines 1742 and a net 1743. While playing the game, the user 5 can enjoy tennis in the virtual space as the avatar 6 in the virtual space 1711 by performing various motions in the real space.

In FIG. 17, virtual cameras 14A1 and 14B1 (hereinafter collectively referred to as “virtual camera 14”) are arranged at the positions of the avatars 6A and 6B, respectively. The virtual camera 14 photographs the virtual space 1711 from the viewpoint of the avatar 6. For example, the field-of-view image from the viewpoint of the avatar 6A photographed by the virtual camera 14A1 includes the tennis court 1741 and the avatar 6B serving as an opponent player on the tennis court 1741, and the field-of-view image from the viewpoint of the avatar 6B photographed by the virtual camera 14B1 includes the tennis court 1741 and the avatar 6A serving as an opponent player on the tennis court 1741. The field-of-view image photographed by each virtual camera 14 may also include the hand 7 of each avatar 6 and the racket 8 grasped by the hand 7. The user 5 can view a video of the virtual space 1711 obtained from the viewpoint of the avatar 6 by the virtual camera 14.

An avatar movable area is also set in the virtual space 1711. The avatar movable area indicates the area in which the avatar 6 may move in the virtual space 1711. In FIG. 17, there is only an avatar movable area 1745 for the avatar 6A, but an avatar movable area may be similarly set for the avatar 6B as well. In FIG. 17, the avatar movable area 1745 of the avatar 6A is set such that the territory on the avatar 6A side of the entire tennis court 1741 and vicinity thereof are included. The user 5A can play tennis on the virtual space 1711 by moving the avatar 6A within the avatar movable area 1745.

The avatar movable area 1745 in the virtual space 1711 is associated with the position of the real space. As at least one example, the user 5 plays a tennis game in a room at home. FIG. 18 is a diagram of a room 1851 at the home of the user 5A according to at least one embodiment of this disclosure. The user 5A can set a play area 1852 for the game in the room 1851. The play area 1852 is an area in which the user 5A can move around while playing the game. As described above, the position of the user 5 in the real space (e.g., position of the HMD 120 or position of controller 300) is detected by the HMD sensor 410. In FIG. 18, there are two HMD sensors 410 are arranged in the room 1851. The user 5 can appropriately determine the play area 1852 by considering the size and shape of the room 1851, obstacles (e.g., furniture) existing in the room 1851, and the performance, arrangement position, direction, and the like of each HMD sensors 410. When the user 5 moves around in the play area 1852, the position of the user 5 is detected by the HMD sensors 410, and the avatar 6 in the virtual space 1711 moves within the avatar movable area 1745 in accordance with the motion of the user 5.

The relationship between a size of the play area 1852 and a size of the avatar movable area 1745 is freely set. As at least one example, a movement of one meter by the user 5 in the real space play area 1852 may be set to correspond to a movement of R meters, where a ratio R is set to a predetermined value, by the avatar 6 in the avatar movable area 1745 of the virtual space 1711. In at least one embodiment, the ratio R is set by the user 5A. In at least one embodiment, the ratio R is set based on the detected size of the real space play area 1852 and the avatar moveable area 1745. As a result, when the user 5 moves from one end to another end of the play area 1852, the avatar 6 moves precisely from one end to another end of the avatar movable area 1745. As at least one example, the play area 1852 may be smaller than the avatar moveable area 1745. In this case, the avatar 6 in the virtual space 1711 may move from one end to another end of the avatar movable area 1745 based on not only the movement of the position of the user 5 detected by the HMD sensors 410, but also by combining with a user input to the controller 300 (e.g., operation input to analog stick 390).

The HMD sensors 410 may detect the position of the user 5 when the user 5 is present in the play area 1852. Asa result, the avatar 6 and the virtual camera 14 of the avatar 6 are arranged at the correct position in the avatar movable area 1745 corresponding to the detection position of the user 5 in the real space, and the field-of-view image generation module 1428 may generate a correct field-of-view image corresponding to the detection position of the user 5 based on the position of the virtual camera 14. However, in certain circumstances, the HMD sensors 410 may not be able to correctly detect the position of the user 5, and as a result, an error occurs in the position of the avatar 6 and the virtual camera 14 in the virtual space 1711. This may prevent the field-of-view image generation module 1428 from generating the correct field-of-view image corresponding to the actual position of the user 5. Examples of such a situation causing an error in the position of the virtual camera 14 include a case in which the user 5 has stepped out of the play area 1852, a case in which the signal from the LED light source on the HMD 120 or the infrared LED 360 on the controller 300 is blocked by some kind of obstacle (e.g., body of the user 5), and a case in which the signal from the HMD 120 or the controller 300 can be received by the HMD sensor 410 but the position of the user 5 cannot be calculated or is erroneous due to some kind of processing error.

Returning to FIG. 16, the processing includes Step 1602. The processor 210 reads out and executes the game program included in the application data 1433 stored in the memory 220.

The processing advances to Step 1604, and the processor 210 sets initial settings for the game. The initial settings include a setting of the play area 1852 like in FIG. 18 and a setting of the avatar movable area 1745 like in FIG. 17.

FIG. 19 is a flowchart of a method 1900 for setting the initial settings in Step 1604 according to at least one embodiment of this disclosure. In Step 1902, the processor 210 identifies the play area of the real space. For example, referring to FIG. 18, the user 5A can perform an operation of setting a quadrangular-shaped play area 1852 by using the controller 300A. The user 5A first stands at a point A (one vertex of the quadrangle) in the room 1851 and presses a predetermined button of the controller 300A. The controller 300A receives the pressing of the button, and transmits a play area setting signal. The HMD sensor 410 receives the play area setting signal from the controller 300A. The processor 210 identifies the position coordinates of the point A, which is the position at which the user 5A has pressed the button of the controller 300A, based on the play area setting signal received by the HMD sensor 410. Next, the user 5A moves to a point B (another vertex of the quadrangle) in the room 1851, and in the same manner, presses a predetermined button of the controller 300A. In response to this user operation, similarly to the case of setting the point A, the processor 210 identifies the position coordinates of point B. The user 5A repeats the same operation for points C and D, and as a result, the processor 210 also identifies position coordinates of the points C and D. Next, the user 5A issues an instruction to end the play area setting operation by pressing a predetermined button of the controller 300A. When the processor 210 receives the instruction, the processor 210 connects the plurality of points (points A, B, C, and D) for which the position coordinates have been identified. As a result, the area enclosed by the line connecting each point is identified as the play area 1852.

The number of points designated by the user 5A to set the play area may be any number of points. Therefore, setting a play area having any shape is possible. The method by which the user 5A sets the play area is not limited to the above-mentioned method. For example, the user 5A can set the play area by, while continuing to press a predetermined button of the controller 300A, walking around the room 1851 so as to draw the outer frame of the play area he or she is trying to set (e.g., walk along, in order, line segments AB, BC, CD, DA of play area 1852). In this case, the processor 210 may continuously track the play area setting signal from the controller 300A, and identify the area enclosed by the locus obtained by the tracking as the play area. The user 5A can also set the play area by once pressing a predetermined button of the controller 300A within a signal-detectable area of the HMD sensor 410 (area in which the HMD sensor 410 is capable of detecting a signal from the controller 300A or the HMD 120A). In this case, as the play area, the processor 210 may identify the signal-detectable area determined by the arrangement position, direction, performance, and the like of the HMD sensor 410.

The processing advances to Step 1904, and the processor 210 identifies the avatar movable area of the virtual space such that the avatar movable area corresponds to the play area identified in Step 1902. For example, referring to FIG. 17 and FIG. 18 collectively, the processor 210 may identify the avatar movable area 1745 by associating (mapping) each point in the play area 1852 set by the user 5A with a corresponding point in a region including the territory on the avatar 6A side of the tennis court 1741 and vicinity thereof on the virtual space 1711. For example, the four corners (points A, B, C, and D) and the center point of the play area 1852 are associated with the corresponding corners or center point of the avatar movable area 1745. Other points in the play area 1852 are each similarly associated with corresponding points in the avatar movable area 1745. As a result, the position of the avatar 6A in the avatar movable area 1745 may be uniquely determined with respect to any position of the user 5A in the play area 1852. In this case, the user 5A can cause the avatar 6A to move around the entire avatar movable area 1745 by moving in the play area 1852. As described above, the size of the play area and the avatar movable area may be different, and when the user moves by a distance d in the play area, the avatar moves by a distance Rxd in the avatar movable area, where R is a predetermined ratio (e.g., ratio between size of play area and size of avatar movable area) associating the movement distance of the user with the movement distance of the avatar.

As at least one example, the processor 210 identifies the region including the territory on the avatar 6A side of the tennis court 1741 and vicinity thereof as the avatar movable area 1745, and associate the play area 1852 as a partial movable area of the avatar movable area 1745. In this case, when the user 5A moves around in the play area 1852, the avatar 6A does not move around the entire avatar movable area 1745, but the avatar 6A moves within a partial movable area, which is a part of the avatar movable area 1745. However, in addition to moving around the play area 1852, the user 5A can also shift the partial movable area in the avatar movable area 1745 by operating the controller 300A. As a result, the avatar 6A can be caused to move around the entire avatar movable area 1745. In this way, the position of the avatar 6A in the avatar movable area 1745 may be determined in accordance with the position of the user 5A in the play area 1852 and a user input to the controller 300A.

The setting of the initial settings for the game ends with the above, and the processing advances to Step 1606 of FIG. 16. In Step 1606, the processor 210 determines whether a tracking signal from the HMD 120 or the controller 300 of the user 5 has been acquired by the HMD sensor 410. For example, when a tennis match by the avatar 6 is started in the virtual space 1711, the HMD 120 and the controller 300 of the user 5 each transmit a tracking signal for enabling tracking of the position of the head or the hand of the user 5 in the real space. The tracking signal is a signal constantly or periodically emitted by the LED light source on the HMD 120 or the infrared LED 360 on the controller 300 lighting up or blinking. Depending on the position or direction of the user 5 with respect to the HMD sensor 410, the tracking signal emitted from the HMD 120 and the controller 300 may not reach the HMD sensor 410 at all, and may be completely unreceivable. In a case like this, in which the HMD sensor 410 has failed to acquire the tracking signal, the processing advances to Step 1614. When the tracking signal is acquired by the HMD sensor 410, the processing advances to Step 1608.

When the tracking signal is acquired by the HMD sensor 410, in Step 1608, the processor 210 detects the position of the user 5 in the real space based on the acquired tracking signal. Step 1608 includes calculating the position coordinates of the head (HMD 120) or the hand (controller 300) of the user 5 in the real space based on the tracking signal. Referring to FIG. 18, for example, the user 5A is in a position in the play area 1852, and the posture of the user 5A is such that the LED light source on the HMD 120A and the infrared LED 360 on the controller 300A are facing the direction of the HMD sensor 410. In such an arrangement, the tracking signal is received by the HMD sensor 410 with good sensitivity, and hence the processor 210 can correctly calculate the actual position coordinates of the head and the hand of the user 5A based on the tracking signals from the HMD 120A and the controller 300A. In an arrangement in which the user 5A has stepped out of the play area 1852, or is present in the play area 1852 but the direction of the LED light source on the HMD 120A or the infrared LED 360 on the controller 300A deviates from the direction of the HMD sensor 410 by a predetermined angle or more, the receiving sensitivity of the tracking signal by the HMD sensor 410 may be insufficient. In such a case, because the processor 210 cannot utilize a good tracking signal, correctly calculating the actual position coordinates of the head and the hand of the user 5A is difficult or impossible. As a result, the calculated position of the head and the hand of the user 5A may indicate an erroneous position different from the actual position.

The processing advances to Step 1610, and the processor 210 controls the position of the operation target object in the virtual space 1711 in accordance with the position of the user 5 in the real space detected in Step 1608. In the virtual space 1711 of FIG. 17, the operation target object includes the virtual camera 14 and the hand 7 of the avatar 6. For example, the processor 210 arranges the virtual camera 14 at the position in the virtual space 1711 corresponding to the position coordinates of the head (HMD 120) of the user 5 in the real space calculated in Step 1608. The processor 210 arranges the hand 7 of the avatar 6 at the position in the virtual space 1711 corresponding to the position coordinates of the hand (controller 300) of the user 5 in the real space calculated in Step 1608. In this way, for example, when the user 5A moves in the play area 1852 or moves his or her hand holding the controller 300A, the user 5A is able to move the avatar 6A of the virtual space 1711 and the virtual camera 14A1 of the avatar 6A in the avatar movable area 1745 in accordance with such a motion of the user 5. In this case, when the position coordinates of the head and the hand of the user 5 calculated in Step 1608 are correct, the motion of the avatar 6 and the virtual camera 14 is a natural motion translated from the motion of the user 5. However, when erroneous position coordinates of the user 5 are calculated in Step 1608, this results in the avatar 6 and the virtual camera 14 exhibiting an unnatural motion. As at least one example, when the position coordinates of the head (HMD 120) of the user 5 are erroneous, the virtual camera 14 suddenly jumps to a place different from the correct place in the virtual space 1711 in accordance with the erroneous position coordinates, and as a result, a discontinuous and unexpected field-of-view image is generated from the field-of-view image generation module 1428. Similarly, when the position coordinates of the hand (controller 300) of the user 5 are erroneous, the hand 1220 of the avatar 6 may move to a place that originally should not exist.

The processing advances to Step 1612, and the processor 210 determines whether the position of the operation target object in the virtual space 1711 is correct. For example, the processor 210 compares the positions of the virtual camera 14 and the hand 1220 of the avatar 6 in the virtual space 1711 before and after execution of Step 1610, and based on the difference, that is, a temporal change (movement speed) of the position, determines whether the positions of the virtual camera 14 and the hand 7 of the avatar 6 are correct. More specifically, when the movement speed of the position of the virtual camera 14 is lower than a predetermined threshold value, the processor 210 determines that the position of the virtual camera 14 is correct, and when the movement speed is higher than the predetermined threshold value, the processor 210 determines that the position of the virtual camera 14 is erroneous. The determination of the position of the hand 7 of the avatar 6 is also performed in a similar manner. As described above, when the reception state of the tracking signal by the HMD sensor 410 is not good, the correct position coordinates of the HMD 120 and/or the controller 300 cannot be detected, and as a result, the virtual camera 14 and the hand 7 of the avatar 6 may suddenly jump to an erroneous position in the virtual space 1711. Therefore, discriminating whether the positions of the virtual camera 14 and the hand 7 of the avatar 6 are erroneous based on whether the positions of the virtual camera 14 and the hand 7 of the avatar 6 have moved abnormally fast is possible. In response to a determination in Step 1612 that the position of the operation target object is correct, the processing advances to Step 1618, and in response to a determination in Step 1612 that the position is erroneous, the processing advances to Step 1614.

In response to a determination that the position of the operation target object is erroneous, in Step 1614, the processor 210 stores in the memory 220 the position of the operation target object at the point in time just before the position becomes erroneous (i.e., last correct position). This position is referred to as “position immediately before error occurrence”. The position immediately before error occurrence can be obtained as the position of the operation target object before the execution of Step 1610. For example, the processor 210 temporarily stores the position of the operation target object before executing Step 1610. When the position of the movement destination of the operation target object as a result of execution of Step 1610 is determined to be erroneous in Step 1612, theprocessor 210 can set the temporarily storedposition as the position immediately before error occurrence. The processor 210 may store in the memory 220 the position immediately before error occurrence together with time information indicating the point in time at which the operation target object was present at the position immediately before error occurrence.

Step 1614 is also executed when the tracking signal cannot be acquired in the determination of Step 1606. The processor 210 may store in the memory 220 the position of the operation target object immediately before the tracking signal becomes impossible to acquire as the above-mentioned position immediately before error occurrence.

When the loop from Step 1606 to Step 1620 is repeatedly executed, every time an error occurs in the position of the operation target object, a position immediately before error occurrence corresponding to the error is sequentially stored in the memory 220. For example, referring to FIG. 17, when the avatar 6A is too close to the right edge of the avatar movable area 1745, an error may occur in the position of the virtual camera 14A1 (this may occur when, for example, the user 5A approaches too close to the right edge of the play area 1852, and the reception state of the tracking signal is no longer good). In this case, the position immediately before error occurrence indicating a position near the right edge of the avatar movable area 1745 is stored in the memory 220. Similarly, when the avatar 6A is too close to the left edge or the right front corner of the avatar movable area 1745, a position immediately before error occurrence indicating a position near the left edge or near the right front corner of the avatar movable area 1745 is stored in the memory 220. In this way, a history of the errors in position (plurality of positions immediately before error occurrence) that have occurred for the operation target object is accumulated in the memory 220.

The processing advances to Step 1616, and the processor 210 generates an image (hereinafter referred to as “erroneous position presentation image”) for visually presenting to the user 5A position immediately before error occurrence based on the positions immediately before error occurrence stored in the memory 220. The erroneous position presentation image may be generated by mapping one or a plurality of positions immediately before error occurrences in the virtual space in a visually identifiable manner. There are now described several specific examples of erroneous position presentation images with reference to the diagrams.

FIG. 20A is a diagram of an erroneous position presentation image 2061 according to at least one embodiment of this disclosure. In FIG. 20A, a top view of the tennis court 1741 and the avatar movable area 1745 in the virtual space 1711 are included. An erroneous position presentation image 2061 in FIG. 20A includes eleven stars 2062 arranged at peripheral portions of the avatar movable area 1745. However, the number and position of the stars 2062 in the erroneous position presentation image 2061 of FIG. 20A are merely an example, and the number and position are not limited thereto. Each of the stars 2062 represents a position immediately before error occurrence recorded once or a plurality of times regarding the HMD 120A or the controller 300A of the user 5A. For example, the processor 210 may generate the erroneous position presentation image 2061 by reading all of the stored positions immediately before error occurrence from the memory 220, and arranging a star 2062 at a corresponding position immediately before error occurrence. The user 5A is able to know, based on the position and the number of the stars 2062, a place at which an error is likely to occur in the tracking of the HMD 120A and the controller 300A when the avatar 6A has moved to the place in the virtual space 1711. In FIG. 20A, the virtual space 1711 is a two-dimensional plane, but the position immediately before error occurrence may be identified by three-dimensional position coordinates including height. Therefore, the processor 210 may arrange the stars 2062 three-dimensionally in accordance with such positions immediately before error occurrence, which enables the erroneous position presentation image 2061 to be represented in three dimensions.

FIG. 20B is a diagram of an erroneous position presentation image 2063 according to at least one embodiment of this disclosure. For the erroneous position presentation image 2063 of the second example, the positions immediately before error occurrence regarding the controller 300A of the user 5A (not HMD 120A) are presented to the user. Therefore, the erroneous position presentation image 2063 in FIG. 20B includes afterimages 2064 of the hand 7A of the avatar 6A in place of the stars 2062 of the position presentation image 2061 in the first example of FIG. 20A. The afterimages 2064 of the hand may have the same appearance as that of the hand 7A of the avatar 6A, or may have a different appearance from that of the hand 7A of the avatar 6A (e.g., hand expressed in a translucent manner). As described above, the position of the hand 7A of the avatar 6A corresponds to the detection position of the controller 300A. In FIG. 20B, when the correct position coordinates of the controller 300A becomes unable to be obtained, the afterimage 2064 ofthehand 7A of the avatar 6A is presented at the position immediately before error occurrence corresponding to that position. The user 5 is able to know places at which errors are likely to occur in the tracking of the controller 300A based on the position and number of the afterimages 2064.

FIG. 21 is a diagram of an erroneous position presentation image 2166 according to at least one embodiment of this disclosure. The erroneous position presentation image 2166 in FIG. 21 represents a plurality of positions immediately before error occurrences as a spatial distribution of color shading. For example, a darker portion of the erroneous position presentation image 2166 indicates that many positions immediately before error occurrence cluster at that position (i.e., position of operation target object tends to be erroneous at that place), and a paler portion indicates that positions immediately before error occurrence are sparse at that position (i.e., position of the operation target tends not to be erroneous at that place). The erroneous position presentation image 2166 of FIG. 21 is merely an example, and any visual representation method capable of representing a spatial distribution may be used. For example, the erroneous position presentation image 2166 may represent the plurality of positions immediately before error occurrence as a spatial distribution of colors, patterns, graphics, or the like. For example, the processor 210 reads all the stored positions immediately before error occurrence from the memory 220, and calculates a local spatial density of the positions immediately before error occurrence. The processor 210 may generate the erroneous position presentation image 2166 by arranging in the virtual space 1711 predetermined different densities, different colors, different patterns, different graphics, or the like corresponding to the spatial density obtained for each place. The user 5 is able to know the places at which errors in the tracking of the HMD 120 and the controller 300 are likely to occur based on the spatial distribution of shading, color, pattern, graphics, or the like in the erroneous position presentation image 2166.

The processor 210 may sequentially update the erroneous position presentation image by using the positions immediately before error occurrence stored in the memory 220 within the most recent time period of a predetermined length. For example, when a position immediately before error occurrence indicating the same place (or region of a certain size) in the virtual space 1711 is recorded a plurality of times during the most recent time period of a predetermined length, the processor 210 may change, in accordance with that number, the representation of the portion corresponding to that position immediately before error occurrence in the erroneous position presentation image. As at least one example, in the erroneous position presentation image 2061 of FIG. 20A, when there are more positions immediately before error occurrence recorded during the most recent time period of a specific length (e.g., most recent period from 30 minutes before to current point in time) for one specific place in the avatar movable area 1745, the star 2062 arranged at that place may be brighter. After that, when no new positions immediately before error occurrence are recorded for the place, the brightness of the star 2062 arranged at that place may be gradually decreased with the passage of time. The user 5 is able to know how often errors in tracking have occurred at that place recently based on the brightness of the star 2062. Similar changes can also be applied to the erroneous position presentation images 2063 and 2166.

The processing advances to Step 1618, and the processor 210 generates a field-of-view image of the virtual space 1711 such that the field-of-view image includes the erroneous position presentation image. The method of generating the field-of-view image is as described above as Step 1506 to Step 1516 of FIG. 15. The field-of-view image is displayed on the monitor 130. As a result, when the user 5 visually recognizes the field-of-view image including the erroneous position presentation image, the user 5 is able to know the positions of the operation target object (virtual camera 14 and hand 7 of avatar 6) at which errors have occurred or tend to occur.

The processing advances to Step 1620, and the processor 210 determines whether to end the game. For example, the processor 210 determines whether to end the game in accordance with a predetermined input instruction from the user 5. When the game is to be continued, the processing returns to Step 1606, and the steps from Step 1606 onward are repeated.

FIG. 22 is a flowchart of a method 2200 according to at least one embodiment of this disclosure. The method 2200 further includes, in addition to the steps of the method 1600 described above, an additional Step 2202 between Step 1616 and Step 1618. In Step 2202, the processor 210 transmits information on the position immediately before error occurrence stored in the memory 220 to the computer 200 of another user. Referring to FIG. 17, the user 5A is sharing the virtual space 1711 with the user 5B. In at least this example, the information on the position immediately before error occurrence regarding the user 5A is transmitted to the computer 200 of the user 5B via the network 2. Similarly, the information on the position immediately before error occurrence regarding the user 5B may be transmitted to the computer 200 of the user 5A. The processor 210 of the computer 200 of the user 5B, which has received the information on the position immediately before error occurrence regarding the user 5A, may generate an erroneous position presentation image as described above based on the position immediately before error occurrence, and display the generated erroneous position presentation image on the HMD 120B of the user 5B including the field-of-view image from the virtual camera 14B1 of the avatar 6B. As a result, the user 5B is able to know the position immediately before error occurrence for the user 5A side, which can be used to determine tactics in the tennis game.

FIG. 23 is a flowchart of a method 2300 according to at least one embodiment of this disclosure. The method 2300 further includes, in addition to the steps of the method 1600 described above, an additional Step 2302 and an additional Step 2304 between Step 1616 and Step 1618. In Step 2302, the processor 210 determines whether a frequency of the position immediately before error occurrence stored in the memory 220 is higher than a predetermined threshold value. The frequency of the position immediately before error occurrence may be defined as, for example, the total number of times that the position of the operation target object in the virtual space 1711 has been erroneous or the number of times that the position of the operation target object in the virtual space 1711 has been erroneous in a predetermined unit time. When the frequency of the position immediately before error occurrence stored in the memory 220 is lower than the predetermined threshold value, the processing advances to Step 1618, and when the frequency is higher than the predetermined threshold value, the processing advances to Step 2304.

When the processing advances to Step 2304, the processor 210 outputs from the HMD 120A a warning to the user 5. The warning may be in any mode, such as video, sound, light, and vibration. As described above, when the position of the virtual camera 14 (operation target object) of the avatar 6 in the virtual space 1711 has become erroneous (e.g., sudden jump to a separate place), the field-of-view image generated by the field-of-view generation module 1428 becomes a discontinuous image that is not expected by the user 5, which may cause user 5 to feel “motion sickness”. Therefore, when the position of the virtual camera 14 becomes frequently erroneous, in Step 2304, for example, a warning is issued to prompt the user 5 to take a break, which may reduce or prevent the motion sickness of the user 5. Such an error in the position of the operation target object may be caused by some kind of problem in the arrangement of the HMD sensor 410 or in the setting oftheplayarea 1852. Therefore, a warning may be issued to prompt the user 5 to arrange the HMD sensor 410 again or to reset the play area 1852.

The threshold value used for the determination in Step 2302 may be changed in accordance with the degree of familiarity of the user 5 with the virtual space. The degree of familiarity of the user 5 with the virtual space is determined based on the behavior of the user 5. For example, the method 2300 may further include, as optional steps (not shown), monitoring the behavior of the user 5, and adjusting the above-mentioned threshold value based on the behavior of the user 5. As the behavior of the user 5, for example, there maybe used a number of times that the position of the operation target object has been erroneous, a period of time from when the position of the operation target object became erroneous until the error is resolved, or a movement amount of the user 5 in the real space. For example, an experienced user familiar with experiences in the virtual space may be able to skillfully perform operations in the real space such that the occurrence of errors in the position of the operation target object is as low as possible. Even when the position of the operation target object is erroneous, an experienced user may be able to quickly perform an appropriate action to return the operation target object to the correct position. However, an inexperienced user not familiar with experiences in the virtual space may perform motions carefully, and as a result, the movement amount in the real space may be less than that of a skilled user. The threshold value of Step 2302 may be appropriately adjusted in accordance with such user behaviors in which familiarity is translated in the virtual space. For example, the threshold value may be increased for experienced users, and reduced for inexperienced users.

FIG. 24 is a flowchart of a method 2400 according to at least one embodiment of this disclosure. The method 2400 further includes, in addition to the steps of the method 1600 described above, an additional Step 2402 between Step 1616 and Step 1618 and an additional Step 2404 between Step 1612 and Step 1618. As described above, when the position of the operation target object is determined to be erroneous in Step 1612, Step 1614 and Step 1616 are executed. After Step 1616, the processing advances to Step 2402, and the processor 210 temporarily stops the progress of the game. As examples of temporarily stopping the progress of the game, the progress of time in the game may be stopped, or actions taken by the avatar 6 may be invalidated (e.g., during temporary stoppage, points are not scored even if the avatar 6 hits the ball). When the position of the operation target object of a user is erroneous, that user is subject to a disadvantageous situation in which he or she is not able play the game normally. Therefore, temporarily stopping the progress of the game enables imbalances undesirable for execution of the game among users to be avoided. After the progress of the game is temporarily stopped, the loop from Step 1606 to Step 1620 is repeated again, and when the position of the operation target object returns to the correct position, the processing advances from Step 1612 to Step 2404. In Step 2404, the processor 210 releases the temporary stoppage of the game, and causes the game to progress normally.

FIG. 25 is a flowchart of a method 2500 according to at least one embodiment of this disclosure. The method 2500 further includes, in addition to the steps of the method 1600 described above, an additional Step 2502 between Step 1606 and Step 1608. In Step 2502, the processor 210 adjusts the above-mentioned ratio R associating the travel distance of the user 5 and the travel distance of the avatar 6 in accordance with the frequency of the position immediately before occurrence stored in the memory 220. For example, the processor 210 increases the ratio R when there is an increased number of times that the position of the operation target object is erroneous. As a result, the user 5 is able to move the avatar 6 by a large amount in the virtual space 1711 by only slightly moving in the real space. Therefore, the user 5 is enabled to move the avatar 6 over the entire range of the avatar movable area 1745 without moving near a peripheral portion of the play area 1852, which enables the possibility that the position of the operation target object is again erroneous due to the user 5 approaching the edge of the play area 1852 to be reduced. The processor 210 may identify, for each direction in the virtual space 1711 (direction as viewed from current position of avatar 6), the frequency of the position immediately before error occurrence stored in the memory 220, and set the ratio R to be higher for directions having a higher frequency, namely, directions in which the number of times that the position of the operation target object is erroneous is higher. As a result, the possibility that the position of the operation target object is erroneous due to the user 5 approaching an edge of the play area 1852 can be reduced more effectively.

Embodiments of this disclosure have been described primarily as being implemented by the processor 210 (or computer 200) or as the method 1600. However, one of ordinary skill in the art would understand that the embodiments of this disclosure may be implemented by a computer program for causing the processor 210 to perform the method 1600.

Although embodiments of this disclosure have been described, one of ordinary skill in the art would understand that those are merely an example and are not intended to limit the scope of this disclosure. One of ordinary skill in the art would understand that changes, additions, improvements, and the like of the embodiments may be made as appropriate without departing from the spirit and scope of this disclosure. The scope of this disclosure should not be limited by any one of the embodiments described above, but should be defined only by the appended claims and their equivalents.

In the various embodiments described above, as an example, there is described a case in which a virtual space is provided in which the user is immersed by using a non-transmissive HMD device. However, a see-through HMD (or partially see-through HMD) may be adopted as the HMD device. In such embodiments, a user experience may be provided in an augmented reality (AR) space or a mixed reality (MR) space through a superimposed display of an image including the real space visually recognized by the user via the see-through HMD device and a virtual object. More specifically, the see-through HMD device may display an erroneous position presentation image on the display of the HMD device in place of the above-mentioned field-of-view image. This enables the user to experience an AR or MR space in which the position immediately before error occurrence is displayed.

In the at least one embodiment described above, the description is given by exemplifying the virtual space (VR space) in which the user is immersed using an HMD. However, a see-through HMD may be adopted as the HMD. In this case, the user may be provided with a virtual experience in an augmented reality (AR) space or a mixed reality (MR) space through output of a field-of-view image that is a combination of the real space visually recognized by the user via the see-through HMD and a part of an image forming the virtual space. In this case, action may be exerted on a target object in the virtual space based on motion of a hand of the user instead of the operation object. Specifically, the processor may identify coordinate information on the position of the hand of the user in the real space, and define the position of the target object in the virtual space in connection with the coordinate information in the real space. With this, the processor can grasp the positional relationship between the hand of the user in the real space and the target object in the virtual space, and execute processing corresponding to, for example, the above-mentioned collision control between the hand of the user and the target object. As a result, an action is exerted the target object based on motion of the hand of the user.

What is claimed is:

1-13. (canceled)

14. 1 method, comprising:
identifying a three-dimensional first area in a real space;
identifying in a virtual space a three-dimensional second area corresponding to the first area;
detecting in the first area a first position of a part of a body of a user when the part of the body is positioned in the first area;
moving, in the second area, an object in the virtual space such that a second position, in the virtual space, of the object corresponds to the first position in the real space;
determining whether an error occurred in the second position based on the first position failing to be detected correctly;
moving the object to an erroneous position in the virtual space;
generating an image including the object in the second area at a position in the virtual space immediately before the object has been moved to the erroneous position; and
displaying the image.

15. The method according to claim 14, wherein determining whether the error occurred is based on a temporal change in the second position.

16. The method according to claim 15, wherein the error is determined to have occurred in response to the temporal change in the second position exceeding a predetermined threshold value.

17. The method according to claim 14, wherein the image is generated by mapping in the virtual space each position. in the second area immediately before the object has been moved to the erroneous position, based on a history in which the error is determined.

18. The method according to claim 17, wherein generating the image comprises generating the image as (a) a spatial distribution of shading, color, pattern, or graphics;(b) as an image of the object; (c) or as an image different from the object.

19. The method according to claim 17, further comprising updating the image based on an acquired history within a period having a predetermined duration from a current point in time.

20. The method according to claim 14, further comprising transmitting information related to the error to a terminal of another user sharing the virtual space with the user.

21. The method according to claim 14, further comprising:
determining whether a frequency at which the error is detected is higher than a threshold frequency; and
issuing a warning to the user in response to the determined frequency being higher than the threshold frequency.

22. The method according to claim 21, further comprising:
monitoring a behavior of the user; and
adjusting the threshold frequency based on the behavior of the user.

23. The method according to claim 22, wherein the behavior of the user comprises at least one of a number of times that the error is detected, a period of time from detection of the error until resolution of the error, or a movement amount of the at least a part of the body of the user in the real space.

24. The method according to claim 14, further comprising temporarily stopping progress of a game in the virtual space in response to the determination of the error.

25. The method according to claim 14, further comprising:
setting a ratio, wherein the ratio defines a distance by which the object is to move in the virtual space in accordance with detected movement of the at least a part of the body of the user; and
adjusting the ratio in accordance with a frequency at which the error is determined.

26. The method according to claim 25, further comprising:
determinin.g the frequency at which the error is determined in association with each of a plurality of directions in the virtual space; and
adjusting the ratio for each direction of the plurality of directions in accordance with the frequency in each corresponding direction.

27. A system comprising:
a non-transitory computer readable medium configured to store instructions thereon; and
a processor connected to the non-transitory computer readable medium, wherein the processor is configured to execute the instructions for:
receiving information related to a three-dimensional first area in a real space;
identifying in a virtual space a three-dimensional second area corresponding to the first area;
detecting in the first area a first position of a part of a body of a user when the part of the body is positioned in the first area;
moving, in the second area, an object in the virtual space such that a. second position, in the virtual space, of the object corresponds to the first position in the real space;
determining whether an error occurred in the second position. based on the first position failing to be detected correctly;
moving the object to an erroneous position in the virtual space;
generating an image including the object in second area at a position in the virtual space immediately before the object has been moved to the erroneous position; and
instructing a display to display the image.

28. The system according to claim 27, wherein the processor is configured to determine the error based on a temporal change in the second position.

29. The system according to claim 28, wherein the processor is configured to determine that the error occurred in response to the temporal change in the second position exceeding a predetermined threshold value

30. The method according to claim 27, wherein the processor is configured to generate the image by mapping in the virtual space each position in the second area immediately before the object has been moved to the erroneous position, based on a history in which the error is determined.

31. The system according to claim 27, wherein the processor is further configured to execute the instructions for transmitting information related to the error to a terminal of another user sharing the virtual space with the user.

32. The system according to claim 27, wherein the processor is further configured to execute the instructions for:
determining whether a frequency at which the error is detected is higher than a threshold frequency; and
generating a warning to the user in response to the determinedfrequency being higher than the threshold frequency.

33. A method, comprising:
receiving information related to a three-dimensional first area in a real space;
identifying in a virtual space a three-dimensional second area corresponding to the first area;
detecting in the first area a first position of a part of a body of a user when the part of the body is positioned in the first area;
moving, in the second area, an object in the virtual space such that a second position, in the virtual space, of the object corresponds to the first position in the real space;
determining whether the part of the body of the user failed to be properly detected;
generating an error signal in response to the determination that the part of the body of the user failed to be properly detected;
generating an image including the object at a position in the virtual space immediately before the error signal was generated; and
displaying the image.
